(19) United States
(12) Patent Application Publication
(10) Pub. No.: US 2021/0039469 A1
(43) Pub. Date: Feb. 11, 2021

(54) CONTROL UNIT FOR AIR MANAGEMENT SYSTEM

(71) Applicant: BASE AIR MANAGEMENT LIMITED, Sydney NSW (AU)

(72) Inventors: Matthew VAUGHAN, Surfers Paradise, Queensland (AU); Joseph CALAWAY, Camden, MI (US); David Bryan LEWIS, Amelia Court House, VA (US); George ARRANTS, Richmond, VA (US)

(73) Assignee: Base Air Management Limited, Sydney NSW (AU)

(21) Appl. No.: 16/966,983

(22) PCT Filed: Oct. 8, 2018
(86) PCT No.: PCT/US2018/054826

§ 371 Date: Aug. 3, 2020

Related U.S. Application Data
(60) Provisional application No. 62/626,385, filed on Feb. 5, 2018.

(51) Int. Cl. B60G 17/052; B60G 21/073

(52) U.S. Cl. CPC B60G 17/0525; B60G 21/073; B60G 2202/152; B60G 2400/252; B60G 2204/82; B60G 2401/14; B60G 2500/302; B60G 2500/2046; B60G 2202/42; B60G 2401/21; B60G 2401/17; B60G 2400/51222

(57) ABSTRACT

An air management system (1200) for leveling a vehicle operated under dynamic driving conditions including an air supply tank (1204); a system controller (1240) integrated with the supply tank (1204); one or more air springs disposed on a first side of the vehicle and one or more air lines (1210) pneumatically connecting the one or more air springs (1230) disposed on the first side of the vehicle with the system controller (1240); one or more air springs (1230) disposed on a second side of the vehicle and one or more air lines (1220) pneumatically connecting the one or more air springs (1230) disposed on the second side of the vehicle with the system controller (1240).

### FIELD OF THE DISCLOSURE

This disclosure relates to an air management system for a vehicle, and in particular, to a control unit for controlling air flow in air springs and air lines of the air management system.

### BACKGROUND

Pneumatic suspension systems have been commonly installed in vehicles for providing vehicle stability and a softer ride. Pneumatic suspension systems typically include an air tank that supplies air to air bags that are installed at the axles of the vehicle to support the vehicle chassis. Pressurized air from the air tank can be forced into or exhausted from one or more of the air bags to provide the vehicle with desired suspension characteristics. Several types of devices have been used to control the delivery and exhaust of air to and from the air bags. One example includes a mechanical leveling valve that is in fluid communication between the air tank and the air bags. Mechanical leveling valves typically include a linkage that moves in response to changes in the suspension height of the vehicle. As the vehicle suspension height changes, the linkage actuates the valve to permit air flow to be transferred into and out of an air bag assembly. In this manner, such mechanical linkage valves can permit control of the height of the air bag assembly.

However, such mechanical leveling valves have numerous problems and/or disadvantages. One problem with the use of mechanical leveling valves is that the linkages are frequently subjected to physical impacts, such as may be caused by debris from a roadway, for example. This can result in the linkage being significantly damaged or broken, such that the valve no longer operates properly, if the valve operates at all. Furthermore, space is limited underneath the vehicle chassis, so mechanical leveling valves need to be strategically placed where there is sufficient space to receive the valves.

One attempt to overcome the difficulties of mechanical leveling valves is incorporating an electronic-controlled leveling valve in the suspension system, which relies on sensors to determine conditions of the air springs. However, these systems may suffer from the added cost and complexity of sensors that are exposed to the harsh under-vehicle environment around the tire. Accordingly, rocks, snow, road salt, sand, mud, and debris may disable or damage the sensors. In addition, installing the sensors to the vehicle is time consuming, especially for vehicles that have not been originally designed for sensor installation.

Accordingly, the present inventors have recognized that there is a need to provide an air management system that uses electronically-actuated valves that are protected from the under-vehicle environment and may easily be installed in the vehicle.

Further, when a vehicle negotiates a turn, the vehicle's center of gravity shifts along its width away from the turn. Due to the weight shift, the air springs on the side of the vehicle facing away from the turn start to contract, while the air springs on the side of the vehicle facing the turn start to extend. Consequently, the vehicle becomes unleveled from side-to-side. In response, one of the leveling valves on the lowered side of the vehicle supplies air to the contracted air springs, while the other leveling valve on the elevated side of the vehicle removes air from the extended air springs to keep the vehicle level. Through testing, it has now been found that leveling valves often overcompensate in responding to dynamic weight shifts of the vehicle, in which the air springs that were supplied air from the leveling valve tend to have a greater air pressure than the air springs that were purged by the leveling valve. As a result, a pressure difference persists between the two sides of the air suspensions system even after the leveling valves attempt to level the vehicle. Even though a pressure differential remains between the air springs on opposite sides of the vehicle, the leveling valves return to a neutral mode (e.g., the rotary disk is set within a dead band range), in which there is a lack of pneumatic communication between the air springs on opposite sides of the vehicle. Due to this pressure differential between the air springs, the vehicle remains unlevel even after the leveling valves have adjusted the pressure of the air springs in response to the vehicle weight shift.

Accordingly, the present inventors have recognized that there is a need for an air management system that solves the problem of persistent pressure imbalances that occur in known pneumatic suspensions so that the vehicle may be restored to equilibrium air pressure, level and ride height.

### SUMMARY

The present disclosure provides an air management system for a vehicle. The air management system comprises a supply tank; a system controller integrated with the supply tank; one or more air springs disposed on a first side of the vehicle and one or more air lines pneumatically connecting the one or more air springs disposed on the first side of the vehicle with the system controller; and one or more air springs disposed on a second side of the vehicle and one or more air lines pneumatically connecting the one or more air springs disposed on the second side of the vehicle with the system controller. In various examples, at least one air spring disposed on the first side of the vehicle and at least one air spring disposed on the second side of the vehicle comprise one or more sensors configured to monitor at least one condition of the air spring and transmit a measurement signal indicating the at least one condition of the air spring. In various examples, the system controller is configured to: (i) receive the signals transmitted from the one or more sensors of each air spring, (ii) detect a height differential between at least one air spring disposed on the first side of the vehicle and at least one air spring disposed on the second side of the vehicle based at least on the received signals from the one or more sensors of each air spring, (iii) independently adjust air pressure of the at least one air spring disposed on the first side of the vehicle such that the first leveling valve is either supplying air from the air supply tank to the at least one air spring disposed on the first side of vehicle or removing air from the at least one air spring disposed on the first side of vehicle to the atmosphere, (iv) independently adjust air pressure of the at least one air spring disposed on the second side of the vehicle by a second leveling valve such that the second leveling valve is either supplying air from the air supply tank to the at least one air spring disposed on the second side of the vehicle or removing air from the at least one air spring disposed on the second side of the vehicle to the atmosphere, (v) detect a pressure differential between the at least one air springs disposed on the first side of the vehicle and the at least one air spring disposed on the second side of the vehicle based at least on the received signals from the one or more sensors of each air spring when both the first leveling valve and the second leveling valve are set in a neutral mode such that the height differential is within a predetermined threshold such that each leveling valve is neither supplying air from the air supply tank or removing air into the atmosphere, and (vi) equalize the air pressure between the at least one air spring disposed on the first side of vehicle and the at least one air spring disposed on the second side of vehicle only when both the first leveling valve and the second leveling valve are set in a neutral mode such that the height differential is within a predetermined threshold.

The present disclosure provides a method for controlling the stability of a vehicle comprising an air management system, wherein the air management system comprising a supply tank, one or more air springs disposed on a first side of the vehicle in pneumatic communication with the supply tank and one or more air springs disposed on a second side of the vehicle in pneumatic communication with the supply tank. The method comprises (i) monitoring, by one or more sensors, at least one condition of at least one air spring disposed on each of the first and second sides of the vehicle; (ii) transmitting, by the one or more sensors, at least one signal indicating the at least one condition of the at least one air spring disposed on each of the first and second sides of the vehicle; (iii) receiving, by a processing module, at least one signal indicating the at least one condition of the at least one air spring disposed on each of the first and second sides of the vehicle; (iv) detecting, by the processing module, a height differential between the at least one air spring disposed on each of the first and second sides of the vehicle based at least on the received signals; (v) independently adjusting, by a first leveling valve, air pressure of the at least one air spring disposed on the first side of the vehicle such that the first leveling valve is either supplying air from the air supply tank to the at least one air spring disposed on the first side of the vehicle or removing air from the at least one air spring disposed on the first side of the vehicle to the atmosphere; (vi) independently adjusting, by a second leveling valve, air pressure of the at least one air spring disposed on the second side of the vehicle such that the second leveling valve is either supplying air from the air supply tank to the at least one air spring disposed on the second side of the vehicle or removing air from the at least one air spring disposed on the second side of the vehicle to the atmosphere; (vii) detecting, by the processing module, an air pressure differential between at least one air spring disposed on each of the first and second sides of the vehicle based at least on the received signals when both the first leveling valve and the second leveling valve are set in a neutral mode such that the height differential is within a predetermined threshold such that first and second leveling valves are neither supplying air from the air supply tank nor removing air into the atmosphere; and (viii) equalizing, by the first and second leveling valves, the air pressure between the at least one air spring disposed on each of the first and second sides of vehicle only when both the first leveling valve and the second leveling valve are set in the neutral mode such that the height differential is within a predetermined threshold.

In one configuration, the system controller is configured to independently adjust the air pressure of the least one air spring disposed on the first side of vehicle to a first air pressure and independently adjust the air pressure of the at least one air spring disposed on the second side of vehicle to a second air pressure when the calculated height differential is greater than a predetermined threshold, in which the first air pressure is not equal to the second air pressure. In one configuration, the one or more sensors comprises a height sensor configured to monitor the height of the air spring and transmit a signal indicating the height of the air spring. In one configuration, the height sensor is an ultrasonic sensor, a laser sensor, an infrared sensor, an electromagnetic wave sensor, or a potentiometer. In one configuration, the one or more sensors comprise a pressure sensor configured to monitor the internal air pressure of the air spring and transmit a signal indicating the internal air pressure of the air spring.

In one configuration, the system controller comprises a housing disposed on an exterior surface of the supply tank. In one configuration, the system controller comprises a housing disposed within the supply tank. In one configuration, the air management system further comprises a compressor disposed within the supply tank.

In one configuration, the one or more sensors comprise an inertial sensor unit comprising an accelerometer, a gyroscope, and a magnetometer. In one configuration, the accelerometer is configured to measure an acceleration with respect to three axes of the vehicle; wherein the gyroscope is configured to measure an angular velocity with respect to three axes of the vehicle; and wherein the magnetometer is configured to measure the magnetic force with respect to three axes of the vehicle. In one configuration, the one or more sensors are configured to transmit a signal indicating the measured acceleration, the angular velocity, and the magnetic force with respect to the three axes of the vehicle; wherein the system controller is configured to receive the signal transmitted from the inertial sensor unit and calculate at least one of the vehicle yaw, vehicle pitch, and vehicle roll, and the system controller is configured to determine the desired air pressure of each air spring based on at least on one of the calculated vehicle yaw, vehicle pitch, and vehicle roll.

The present disclosure provides an air management system for a vehicle. The air management system comprises a supply tank; a system controller integrated with the supply tank; one or more air springs disposed on a first side of the vehicle and one or more air lines pneumatically connecting the one or more air springs disposed on the first side of the vehicle with the system controller; and one or more air springs disposed on a second side of the vehicle and one or more air lines pneumatically connecting the one or more air springs disposed on the second side of the vehicle with the system controller. In various examples, at least one air spring disposed on the first side of the vehicle and at least one air spring disposed on the second side of the vehicle comprise one or more sensors configured to monitor at least one condition of the air spring and transmit a measurement signal indicating the at least one condition of the air spring. In various examples, the system controller is configured to: (i) receive the signals transmitted from the one or more sensors of each air spring, (ii) calculate a height or pressure differential between the air springs disposed on the first and second sides of the vehicle based at least on the received signals from the one or more sensors of each air spring, and (iii) equalize the air pressure between the at least one air spring disposed on the first side of vehicle and the at least one air spring disposed on the second side of vehicle when the calculated height or pressure differential is within a predetermined threshold.

The present disclosure provides a control unit associated with an air spring of air management system for a vehicle. The control unit comprises a housing configured to be mounted to a top plate of the air spring, wherein the housing comprises a valve chamber; a valve disposed in the valve chamber, wherein the valve is configured to selectively remove air from or supply air to a chamber of the air spring at a plurality of volumetric flow rates; one or more sensors configured to monitor at least one condition of the air spring and generate a measurement signal indicating the at least one condition of the air spring; a communication interface configured to transmit and receive data signals to and from a second control unit associated with a second air spring of the air management system; and a processing module operatively linked to the valve, the one or more sensors, and the communication interface. In various examples, the processing module is configured to: (i) receive one or more measurement signals from the one or more sensors of its associated air spring and one or more data signals from the second air spring, (ii) calculate a height or pressure differential between the first and second air springs based at least on the received one or more measurement signals and the one or more data signals, and (iii) actuate the valve to set an air pressure of its associated air spring to an air pressure of the second air spring when the calculated height or pressure differential is within a predetermined threshold.

The present disclosure provides a method for controlling the stability of a vehicle comprising an air management system, wherein the air management system comprising a supply tank, one or more air springs disposed on a first side of the vehicle in pneumatic communication with the supply tank and one or more air springs disposed on a second side of the vehicle in pneumatic communication with the supply tank. The method comprises (i) monitoring, by one or more sensors, at least one condition of the one or more air springs disposed on the first side of a vehicle and the one or more air springs disposed on the second side of a vehicle; (ii) transmitting, by the one or more sensors, at least one signal indicating the at least one condition of the one or more air springs disposed on the first and second sides of the vehicle; (iii) receiving, by a processing module, at least one signal indicating the at least one condition of the one or more air springs disposed on the first and second sides of the vehicle; (iv) calculating, by the processing module, a height or pressure differential between the one or more air springs disposed on the first side of the vehicle and the one or more air springs disposed on the second side of the vehicle based on at least the received signals; and (v) actuate, by the processing module, one or more valves to equalize the air pressure between the one or more air springs disposed on the first side of the vehicle and the one or more air springs disposed on the second side of the vehicle when the calculated differential is within a predetermined threshold.

In one configuration, the system controller is configured to independently adjust the air pressure of the least one air spring disposed on the first side of vehicle to a first air pressure and independently adjust the air pressure of the at least one air spring disposed on the second side of vehicle to a second air pressure when the calculated height differential is greater than a predetermined threshold, in which the first air pressure is not equal to the second air pressure. In one configuration, the one or more sensors may include a height sensor configured to monitor the height of the air spring and transmit a signal indicating the height of the air spring. In one aspect, the height sensor is an ultrasonic sensor, a laser sensor, an infrared sensor, an electromagnetic wave sensor, or a potentiometer. In one aspect, the one or more sensors comprise a pressure sensor configured to monitor the internal air pressure of the air spring and transmit a signal indicating the internal air pressure of the air spring.

In one aspect, the housing of the control unit may comprise an inlet port configured to receive air flow from an air source, an outlet port configured to release air to the atmosphere, and a delivery port configured to supply or release air to and from the chamber of the air spring, wherein the valve chamber is connected to the inlet port, the outlet port, and the delivery port by a plurality of passages. In one configuration, the one or more sensors may comprise a height sensor configured to monitor the height of the air spring and generate a signal indicating the height of the air spring. In one configuration, the height sensor is an ultrasonic sensor, an infrared sensor, an electromagnetic wave sensor, a laser sensor, or a potentiometer. In one configuration, the one or more sensors may comprise a pressure sensor configured to monitor the internal air pressure of the air spring and generate a signal indicating the internal air pressure of the air spring.

In one configuration, the valve chamber, the valve, and the processing module are mounted below the top plate and disposed in the chamber of the air spring. In one configuration, the valve chamber, the valve, and the processing module are mounted above the top plate and disposed outside the chamber of the air spring.

In one configuration, the valve comprises a cylindrical-shaped manifold, a valve member disposed in the manifold and in sliding engagement with an interior surface of the manifold, and an electronic actuator operatively linked to the valve member and the processing module. The manifold may comprise a plurality of openings disposed along a side surface of the manifold, and the electronic actuator is configured to actuate the valve member to slide along the longitudinal axis of the manifold to control the exposure of the plurality of openings such that air is supplied to or removed from the air spring at the desired volumetric flow rate.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various aspects of the subject matter of this disclosure. In the drawings, like reference numbers indicate identical or functionally similar elements.

FIG. 1 is a schematic view of an air management system according to the present invention.

FIG. 2 is a schematic view of an air management system according to the present invention.

FIG. 3A is a schematic view of an air management system according to the present invention.

FIG. 3B is a schematic view of an air management system according to the present invention.

FIG. 4 is a schematic view of an air management system according to the present invention.

FIG. 5 is a schematic view of a control unit according to the present invention.

FIG. 6 is a schematic view of a system controller according to the present invention.

FIG. 7 is a schematic view of a control unit according to the present invention.

FIG. 8 is a schematic view of a system controller according to the present invention.

FIG. 9A is a schematic view of a valve according to the present invention.

FIG. 9B is a cross-section view of a valve according to the present invention taken along line A in FIG. 9A.

FIG. 10 is a schematic view of an air management system according to the present disclosure.

FIG. 11 is a schematic view of an air management system according to the present disclosure.

FIG. 12 is a schematic view of an air management system according to the present disclosure.

FIG. 13 is a schematic view of an air management system according to the present disclosure.

FIG. 14 is a schematic view of an air management system according to the present disclosure.

FIG. 15 is a schematic view of an air management system according to the present disclosure.

FIG. 16 is a schematic view of an air management system according to the present disclosure.

FIG. 17 is a schematic view of an inertial sensor unit according to the present disclosure.

FIG. 18 is a schematic view of a system controller according to the present disclosure.

FIG. 19 is a schematic view of a manifold housing according to the present disclosure.

FIG. 20 is a schematic view of a manifold housing according to the present disclosure.

FIG. 21 is a flow chart of a method for controlling stability of a vehicle according to the present disclosure.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or aspects so described and illustrated.

As used herein, the terms “exhaust,” “purge,” “release,” or “remove,” are intended to be used interchangeably and refer to the act of displacing air from the chamber of an air spring.

In one example, the air lines are provided to supply equal volumes of air to maintain symmetry within the air springs on both sides of the vehicle. The air lines are of substantially the same (e.g., within ±10% or ±5% or ±2% or ±1%) or equal diameter and/or length. The supply lines are of substantially the same (e.g., within ±10% or ±5% or ±2% or ±1%) or equal diameter and/or length.

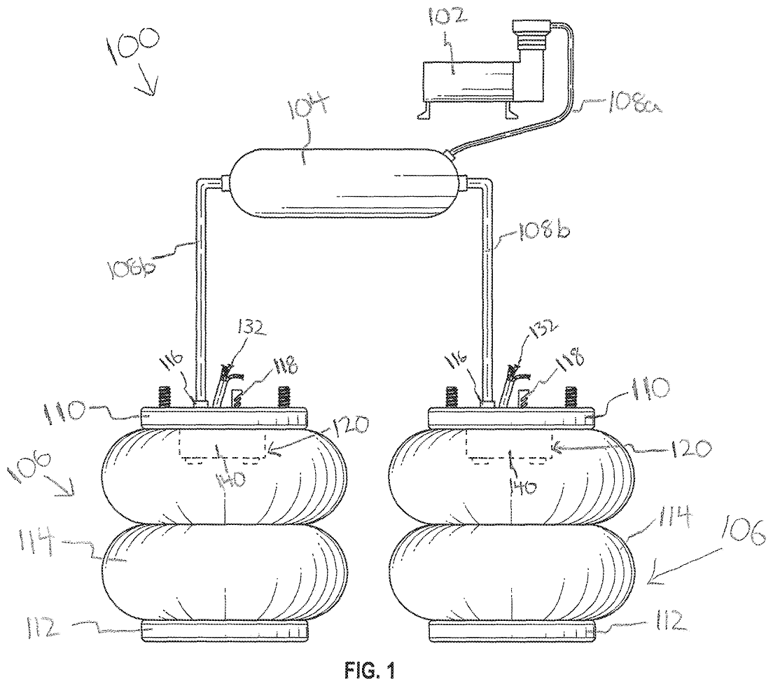

FIG. 1 shows a configuration of an air management system for a vehicle, as disclosed herein, indicated by reference number 100. The air management system 100 includes an air source (e.g., compressor) 102, an air supply tank 104, a plurality of air springs 106, and a series of hoses 108a-b connecting the compressor and the air springs to the air supply tank. The air source 102 may include any suitable components or devices for generating a pressurized air flow to the air supply tank 104. The series of hoses 108a-b include a supply line 108a extending from the air source 102 to the air supply tank 104 and a plurality of spring lines 108b, in which each spring line 108b extends from the air supply tank 104 to a respective air spring 106. The air management system 100 is configured to selectively supply pressurized air flow from the air source 102 to the air springs 106.

Referring to FIG. 1, each air spring 106 comprises a top plate 110 configured to be secured to a frame of a vehicle chassis (not shown), a base plate 112 configured to be secured to a vehicle axle (not shown), and a bellow wall 114 extending from the top plate 110 to the base plate 112. A first end of the bellow wall 114 is hermetically attached to the top plate 110, and a second end of the bellow wall 114 is hermetically attached to the base plate 112, thereby forming a sealed chamber between the interior surfaces of the top plate 110, base plate 112, and the bellow wall 114. As used herein, the term “chamber” may include one or more chambers. In one example, the bellow wall 114 comprises an elastomeric material, such as rubber, so that the bellow wall 114 may be contracted and expanded in response to load and displacement on the air spring. In the present context, an elastomeric material refers to a material that may be elastically strained by application of a force and substantially returns to its previous shape or configuration upon removal of the force. The air spring 106 comprises a fitting 116 disposed in the top plate 110 and projecting away from a first surface of the top plate 110. The fitting 116 is configured to connected to the air spring line 108b so that air may enter into the chamber of the air spring 106, thereby increasing the air pressure of the air spring 106. The air spring 106 comprises an air exhaust port 118 disposed in the top plate 110 and projecting away from the top surface of the top plate 110. The air exhaust port 118 is configured to release air from the chamber of the air spring 106 to the atmosphere, thereby reducing the air pressure of the air spring 106.

As shown in FIG. 1, a control unit 120 is disposed within the chamber of the air spring 106 and comprises a housing 140 mounted to a second surface of the top plate 110 that is opposite the first surface of the top plate 110. By being disposed within the chamber of the air spring 106, the control unit 120 is not exposed to the outside environment, thereby being protected from damage caused by debris or inclement weather conditions. The control unit 120 is configured to adjust the height of the air spring 106 to a desired height that is determined based on one or more operating conditions monitored by the control unit 120. The control unit 120 may take into account conditions of other air springs 106 of the air management system 100 in determining the desired height for its associated air spring 106, but the control unit 120 adjusts the height of its associated air spring 106 independent to the other control units 120 of the air management system 100. Ultimately, by adjusting the air spring 106 to a desired height, the control unit 120 maintains the roll stability and ride quality of the vehicle. The air spring 106 may include other components, such as a bump stop or limiting strap, to prevent the air spring 106 from full jounce or full rebound.

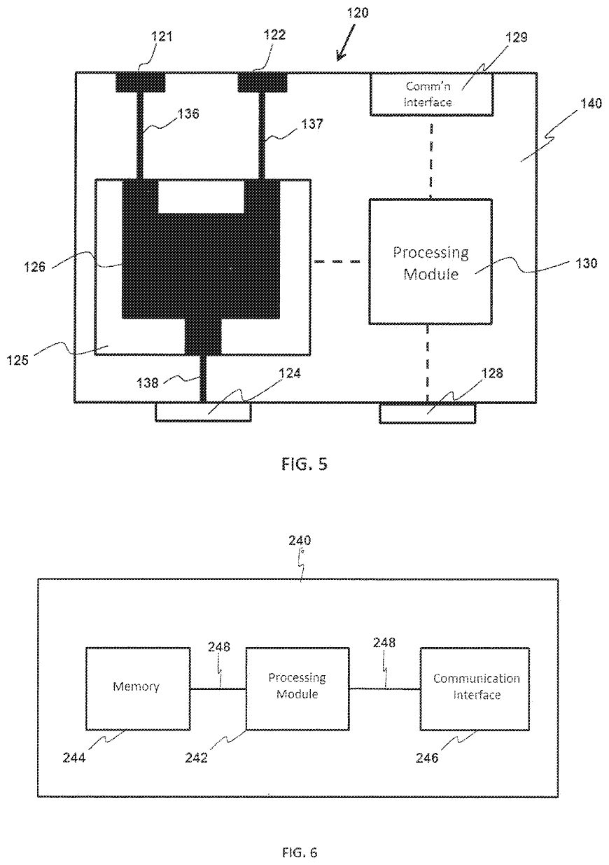

Referring to FIGS. 1 and 5, the control unit 120 comprises an inlet port 121 disposed along a first surface of the housing 140, an outlet port 122 disposed along the first surface of the housing 140, and a delivery port 124 disposed along a second surface of the housing 140. The control unit 120 comprises a valve chamber 125 and a plurality of passages 136, 137, and 138 connecting the delivery port 124, the inlet port 121, and the outlet port 122 to the valve chamber 125. The inlet port 121 is configured to connect to the fitting 116, thereby establishing pneumatic communication between the air supply tank 104 and the control unit 120. The outlet port 122 is configured to connect to the exhaust port 118, thereby establishing pneumatic communication between the atmosphere and the control unit 120. The delivery port 124 is configured to establish pneumatic communication between the valve chamber 125 and the chamber of the air spring 106 such that air may be supplied into or release from the chamber of the air spring 106.

As shown in FIG. 5, the control unit 120 comprises a valve 126 disposed in the valve chamber 125 for selectively controlling the supply and exhaust of air to and from the chamber of the air spring 106. The valve 126 is configured to switch between a plurality of states, including a first state in which the air is released out of the chamber of the air spring 106, a second state in which the air is supplied into the chamber of the air spring 106, and a third state in which the chamber of the air spring 106 is pneumatically isolated such that air is neither delivered into nor released out of the chamber of the air spring 106. In the first state, the valve 126 establishes pneumatic communication between the inlet port 121 and the delivery port 124. In the second state, the valve 126 establishes pneumatic communication between the outlet port 122 and the delivery port 124. In the third state, the valve 126 shuts off pneumatic communication from the inlet 121 and outlet 122 ports.

The valve 126 may take any suitable form or configuration, such as a two-way, three-way, or variable position valve, to selectively control the flow of air in and out of the chamber of the air spring 106 at a plurality of flow rates. In one example, the valve 126 is an electronic-actuated gate valve. In another example, the valve 126 comprises a rotary member disposed in the valve chamber and an electronic actuator operatively linked to the rotary member. In one configuration, the electronic actuator is a stepper motor. The rotary member is configured to rotate between a plurality of positions including a first position establishing pneumatic communication between the inlet port and the delivery port, a second position establishing pneumatic communication between the outlet port and the delivery port, and a third position shutting off pneumatic communication between the delivery port and the inlet and outlet ports. The electronic actuator (e.g., stepper motor) is configured to receive energy from a power source and actuate movement of the rotary member between the plurality of positions. In some configurations, the rotary member is a disk comprising a plurality of holes configured to selectively overlie the plurality of passages at the first, second, and third positions, and the stepper motor includes a shaft that is rotatably coupled to the disk. In some configurations, the stepper motor is configured to actuate movement of the rotary member to a plurality of positions such that the volumetric flow rate for supplying or removing air from the chamber may vary at each respective position of the rotary member. Accordingly, the stepper motor may actuate movement of the rotary member to a first position, in which air is supplied or removed from the chamber of the air spring 106 at a first rate, and the stepper motor may actuate movement of the rotary member to a second position, in which air is supplied or removed from the chamber of the air spring 106 at a second rate that is greater or less than the first rate.

In another example, the valve 126 may include a plunger received in the valve chamber 125 and a solenoid operatively connected to the plunger. The plunger is configured to slide within the valve chamber between a plurality of positions, including a first position establishing pneumatic communication between the inlet port and the delivery port, a second position establishing pneumatic communication between the outlet port and the delivery port, and a third position shutting off pneumatic communication between the delivery port and the inlet and outlet ports. The solenoid is configured to receive energy from a power source and actuate movement of the plunger between the plurality of positions. In some configurations, the solenoid is configured to actuate movement of the plunger to a plurality of positions such that the volumetric flow rate for supplying or removing air from the chamber may vary at each respective position of the plunger.

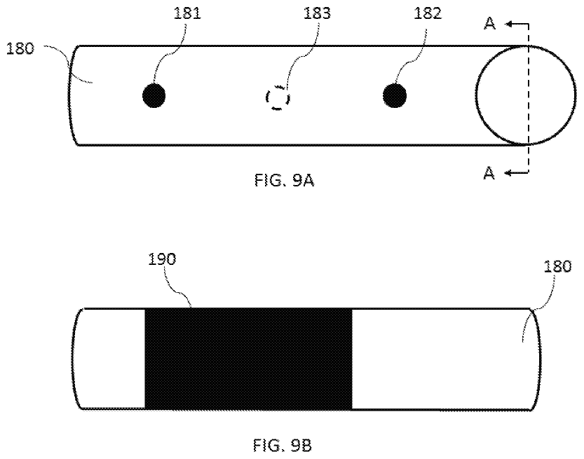

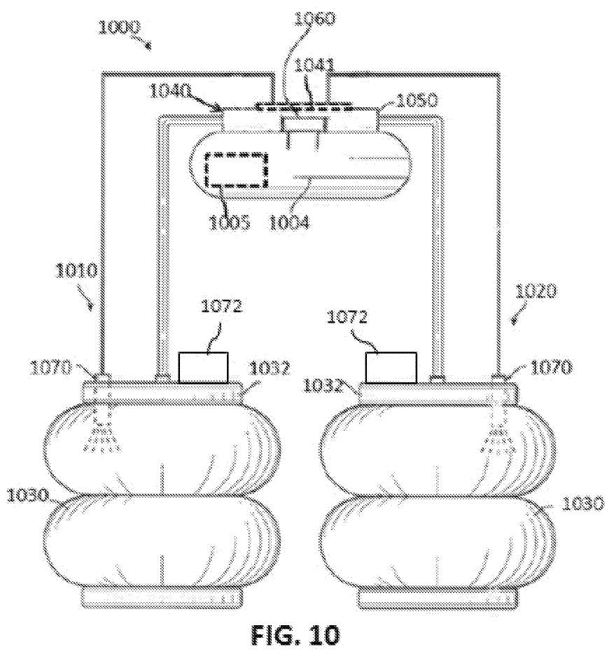

In another example as shown in FIGS. 9A and 9B, the valve 126 may include a cylindrical-shaped manifold 180 and a throttle element 190 telescopically received in the manifold 180 such that the throttle element 190 is in sliding engagement with the interior surface of the manifold 180. The manifold 180 includes a plurality of openings disposed along a surface of the manifold. The plurality of openings 181-183 include a first opening 181 disposed approximate a first end of the manifold 180, a second opening 182 disposed approximate a second end of the manifold 180, and a third opening 183 disposed between the first and second openings 181, 182 and disposed on an opposite side of the manifold 180 to the first and second openings 181, 182. The first opening 181 is in direct pneumatic communication with the inlet port 121. The second 182 opening is in direct pneumatic communication with the outlet port 122. The third opening 183 is in direct pneumatic communication with the delivery port 124. In one configuration, the throttle element 190 is configured to receive an electric signal and slide along the longitudinal axis of the manifold 180 in response to receiving an electric signal. By sliding along the longitudinal axis of the manifold 180, the throttle element 190 is configured to control the exposure of the first, second, and third openings such that the valve 126 is configured to selectively supply or remove air from the chamber of the air spring. The displacement of the throttle element 190 further controls the rate of air flow through the control unit 120. The valve 126 may include an electronic actuator configured to trigger movement of the throttle element along the longitudinal axis of the manifold. In another configuration (not shown), the throttle element is configured to rotate about the longitudinal axis of the manifold in response to receiving an electric signal. By rotating about the longitudinal axis of the manifold, the manifold is configured to control exposure of the first, second, and third openings such that the valve 126 is configured to selectively supply or remove air from the chamber of the air spring. The valve 126 may include an electronic actuator to trigger rotation of the throttle element within the manifold.

The control unit 120 comprises one or more sensors 128, a communication interface 129, and a processing module 130 operatively linked to the one or more sensors 128 and the communication interface 129. In some configurations, the control unit 120 may comprise a power source (not shown), such as a rechargeable battery and/or a supercapacitor integrated with the housing 140 of the control unit 120 or external to the housing 140 of the control unit 120, to provide operating power to the one or more sensors, communication interface, and processing module. The power source may be operatively linked to the power supply of the vehicle to receive a recharging current.

The one or more sensors 128 may be any suitable configuration or device for sensing a condition of the vehicle or any of the components of the air management system. In one example, the one or more sensors 128 include a height sensor configured to continuously monitor the axial distance between the top plate 110 and the base plate 112 as the top and base plates move toward and away from each other in response to load and displacement on the air spring 106. The height sensor is configured to generate a signal indicating a height or distance associated with the air spring 106, such as the axial distance between the top plate 110 and the base plate 112. In one configuration, the height sensor may be an ultrasonic sensor, in which the sensor transmits ultrasonic waves, detects the waves reflected from base plate 112, and determines the axial separation between the top plate 110 and base plate 112 based on the detected waves. In another configuration, the height sensor may be a laser or an infrared sensor, in which the sensor transmits light by a transmitter, receives a reflected light by a receiver, and determines the axial separation between the top and base plates based on the amount of light radiation reflected to the receiver. The height sensor may be any other suitable type or configuration for monitoring the height of the air spring 106, such as a potentiometer, linear position transducer, or an electromagnetic wave sensor. The one or more sensors may include a pressure sensor configured to continuously monitor the internal air pressure of the air spring 106 and generate a signal indicating the internal air pressure of the air spring 106. In one configuration, the pressure sensor is a pressure transducer. The one or more sensors may include a temperature sensor configured to continuously monitor the temperature of the air spring 106 chamber.

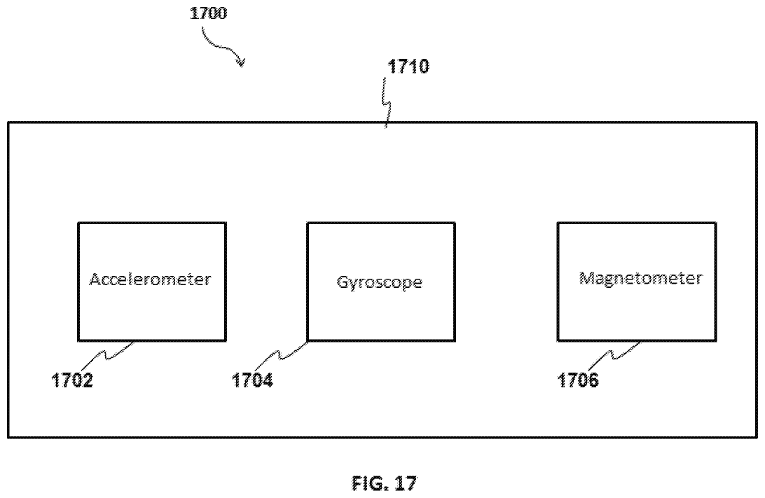

Referring to FIG. 17, in one example, the one or more sensors 128 may include an inertial sensor unit 1700 comprising an accelerometer 1702, a gyroscope 1704, and magnetometer 1706 integrated on a PCB 1710. In one example, the accelerometer 1702 comprises two or more fixed plates (not shown) and a reciprocating member (not shown) configured to reciprocate in motion between the fixed plates in response to forces acting on the vehicles or vehicle motion, whereby the capacitance between the fixed plates changes based on the displacement of the reciprocating member. The accelerometer 1702 is configured to measure acceleration with respect to an axis of the vehicle by detecting a change in capacitance between the fixed plates and correlating the change in capacitance to an acceleration value. In one example, the gyroscope 1704 comprises at least two fixed plates (not shown) and an oscillating member (not shown) configured to move in response to forces acting on the vehicles or vehicle motion, whereby the capacitance between the fixed plates changes based on the perpendicular displacement of the oscillating member. The gyroscope is configured to measure an angular velocity with respect to an axis of the vehicle by detecting a change in capacitance between the fixed plates and correlating the change in capacitance to an angular velocity. In one example, the magnetometer 1706 is a Hall Effect sensor that comprises a conductive plate (not shown) and a meter (not shown) configured to detect the voltage between the two sides of the conductive plate. The magnetometer 1706 is configured to measure a magnetic force with respect to an axis of the vehicle based on the detected voltage.

In one example, the accelerometer 1702 is configured to measure acceleration with respect to three axes of the vehicle, and the gyroscope 1704 is configured to measure an angular velocity along the three axes of the vehicle. The magnetometer 1706 is configured to measure a magnetic force along the three axes of the vehicle. In one example, the accelerometer 1702, the gyroscope 1704, and the magnetometer 1706 are synced such that the inertial sensor unit 1700 detects measurements along nine axes of the vehicle and transmits signals indicating the measurements to the processing module 130.

The communication interface 129 may be any suitable device or component for relaying analog or digital signals to, from, and between the processing module 130 and the control units of other air springs 106 of the air management system 100 and/or other vehicle operating systems. In the illustrated configuration shown in FIG. 1, the air spring 106 includes a plurality of leads 132 that connect the control unit 120 to the control units of other air springs 106 of the air management system 100 and other vehicle operating systems, such as a Controller Area Network, Roll Stability Control (RSC), Electronic Stability Control (ESC), Antilock Brake System (ABS), Automatic Traction Control (ATC), Positive Traction Control (PTC), Automated Emergency Braking (AEB), Electronic Braking System (EBS), collision avoidance systems, etc. The communication interface 129 is configured to receive any signals received from the wired leads 132 and relay those signals to the processing module 130. The communication interface 129 is configured to receive any signals generated by the processing module 130 and transmit those signals over the wired leads 132 to the control units of other air springs of the air management system and other vehicle operating systems. Accordingly, the control unit 120 for each air spring 106 may be in electrical communication with the control units of the other air springs 106 of the air management system 100 such that the control unit may directly transmit and receive data or commands to and from the control units of the other air springs without relaying the signals through other system components.

The processing module 130 of the control unit may be any suitable device or component for receiving input signals from the one or more sensors and the communication interface and outputting commands to adjust height of the air spring 106 to a desired height based on the received input signals. The processing module 130 may comprise one or more processors, central processing units, application specific integrated circuits, microprocessors, digital signal processors, microcontrollers or microcomputers. The processing module 130 may further comprise memory, such as read-only memory, to store all necessary software that embodies the control strategy and mathematical formulations for the operation of the control unit. The processing module 130 may comprise an oscillator and clock circuit for generating clock signals that allow the processing module 130 to control the operation of the control unit. The processing module 130 may comprise a driver module, such as a driving circuit, operatively linked to the valve such that the processing module may selectively actuate valve. The processing module 130 may signal the driver module to actuate the valve in any suitable manner, such as by pulse width modulation or hit-and-hold actuation. For example, the processing module 130 may alter the rotation of the valve by modulating the electronic signal transmitted from the driver module to the electronic actuator of the valve. The processing module 130 may include a sensor interface for receiving signals generated by the one or more sensors. The processing module 130 may comprise an analog-to-digital converter linked to the sensor interface so that analog signals received from the one or more sensors may be converted to digital signals. In turn, the digital signals are processed by the processing module 130 to determine one or more conditions of the air spring 106, such as spring height or internal air pressure. Accordingly, the processing module 130 is configured to receive all the necessary inputs to calculate a desired air pressure for the air spring 106, determine the necessary air flow rate to alter the air pressure of the air spring 106, and convey commands in terms of supplying or purging air to the valve 126 of the control unit 120.

The control unit 120 operates as a closed-loop control system to adjust the height and air pressure of the air spring 106 to a desired height and pressure based on the monitored operating conditions of the vehicle. The monitored operating conditions of the vehicle may include the measurement signals generated by the one or more sensors of the control units and the signals received from other operating systems of the vehicle. The monitored operating conditions are used as constant feedback to the processing module 130 of the control unit 120 so that the control unit 120 may continuously adjusts the height and air pressure of its associate air spring 106 while the vehicle is operating at a dynamic state. Accordingly, the control unit 120 may adjust the height and air pressure of the air spring 106 to enhance dynamic control of the vehicle, such as improved maneuvering, increased traction, better turn handling, improved braking, and improved accelerating. Using the disclosed air management system, it has been possible to achieve significantly reduced driver fatigue and reduced physical tolls on vehicle occupants, as well as safety enhancements such as lowered risk of rollovers and jackknifing.

In operation, the processing module 130 receives inputs from the one or more sensors 120, such as the height sensor and the pressure sensor, to determine the height and the internal air pressure of the air spring 106. The processing module 130 commands the communication interface 129 to transmit signals indicating the spring height and the internal air pressure of the air spring 106 to the control units 120 of the other air springs 106 of the air management system 100. In return, the communication interface 129 may receive data signals from the control units 120 of the other air springs 106 and relay those data signals as inputs to the processing module 130. The processing module 130 then determines the desired air pressure for its associated air spring 106 based on inputs from the one or more sensors 128 and data signals received from the other air springs 106 of the air management system 100. In determining the desired air pressure for the air spring 106, the processing module 130 may take into account the differences in air pressures between all the air springs 106 of the air management system so that the processing module 130 may determine the vehicle pitch and roll rates. The processing module 130 determines the flow rate needed to adjust the internal air pressure of the air spring 106 based on the vehicle roll and pitch rates.

In one configuration, the calculated flow rate is based on how fast the height of the air spring 106 is changing in response to a load or displacement (i.e., height differential rate). Based on the height differential rate and the internal pressure of the air spring 106 and the differences between heights of the air springs 106 of the air management system 100, the processing module 130 is configured to determine the desired air pressure and flow rate needed to adjust the air spring 106 to provide optimal stability and comfort for the vehicle. After determining the desired air pressure and flow rate, the processor is configured to control the flow rate of air being exhausted from or supplied to the air spring 106. While each control unit 120 may determine the desired air pressure for its associated air spring 106 based at least partly on the spring heights of the other air springs 106, each control unit 120 acts independent to other control units 120 of the air management system. In other words, the control unit 120 may adjust the air pressure and height of its associated air spring 106 without influencing the air pressure and height of the other air springs 106 of the air management system 100. Accordingly, the air pressure for each air spring 106 of the air management system may be adjusted at a different rate independently, which results in the vehicle achieving the desired stable position at a faster rate.

In one configuration, the processing module 130 is configured to receive a first set of measurement signals, such as height and pressure measurements of the air spring 106, from the one or more sensors 128 and data signals from the communication interface 129. The data signals may include measurement signals from control units 120 of other air springs 106 of the air management system 100. Based on the first set of measurement and data signals, the processing module 130 is configured to calculate a current state of its associated air spring 106, the current state of the other air springs 106 of the air management system 100, and a dynamic operating state of the vehicle. Based on the calculated current states of the air springs 106 and the dynamic operating state of the vehicle, the processing module 130 is configured to determine a desired air pressure, a desired spring height, and a desired flow rate of air supply or removal for its associated air spring 106. The processing module 130 is configured to actuate the valve 126 to adjust independently the air pressure and height of its associated air spring 106 according to the desired air pressure, desired spring height, and desired flow rate. After the valve 126 of the control unit 120 adjusts independently the air pressure and height of its associated air spring to the desired air pressure, desired spring height, and desired flow rate, the processing module 130 is configured to receive a second set of measurement signals from the one or more sensors 128 and data signals from the communication interface 129. Based on the second set of measurement signals and data signals, the processing module 130 is configured to calculate a difference between the air pressure of its associated air spring 106 and the air pressure of at least one of the other air springs 106 of the air management system 100 (e.g., an air spring 106 disposed on the opposite of the vehicle axle). If the processing module 130 determines that the difference between the air pressure of its associated air springs 106 and the air pressure of the at least one of the other springs 106 is within a predetermined tolerance, then the processing module 130 actuates the valve 126 to set the air pressure of its associated air spring 106 to equal the air pressure of the at least one other air spring 106 of the air management system. Accordingly, the control units 120 of the air management system 100 may equalize the air pressure between all the air springs 106 of the air management system 100 after each control unit 120 adjusts independently the height and air pressure of its associated air spring.

The current state of an air spring 106 may include the current height of the air spring, the current internal pressure of the air spring, the height differential rate of the air spring, and/or the internal pressure differential rate of the air spring. The dynamic operating state of the vehicle may include the vehicle pitch rate and the vehicle roll rate. Vehicle pitch is a relative displacement between the front and rear of a vehicle, which may be represented by a rotation about a lateral axis passing through the center of mass of the vehicle. Accordingly, the vehicle pitch rate refers to the angular motion velocity of the vehicle about its lateral axis, the axis extending from one side to the opposite side of the vehicle. Vehicle roll is a relative displacement between two sides of a vehicle, which may be represented by a rotation about a longitudinal axis passing through the center mass of the vehicle. Accordingly, the vehicle roll rate refers to the angular motion velocity of the vehicle body relative to its longitudinal axis, i.e., the axis that extends from the back of the vehicle to the front. Vehicle yaw is a relative displacement between the front and rear of a vehicle, which may be represented by a rotation about a vertical axis passing through the center of mass of the vehicle. Accordingly, the vehicle yaw rate refers to the angular motion velocity of the vehicle about its vertical axis, the axis extending from a bottom side to a top side of the vehicle.

In one configuration, the processing module 130 is configured to calculate the vehicle yaw, pitch, and roll rates based on the measurement signals received from the inertial sensor unit 1700. The processing module 130 may compare the calculated yaw, pitch, and roll rates to other sensor measurements, such as height sensors, steering angle sensors, stability control systems, vehicle brake systems to ensure for validity and accuracy. The processing module 130 is configured to measure vehicle forces, yaw rate, vehicle pitch, vehicle body roll, and vehicle slip angle and determine the desired air pressure for its associated air spring based on the monitored measurements. Accordingly, determining the desired air pressure based on input from height sensors, air pressure sensors, and the inertial sensor unit 1700, the processing module 130 maintains proper vehicle steering geometry, proper vehicle side-to-side air spring rates, appropriate vehicle wedge angle corrections, and proper vehicle suspension symmetry while driving on all type so road surfaces, terrains, and conditions.

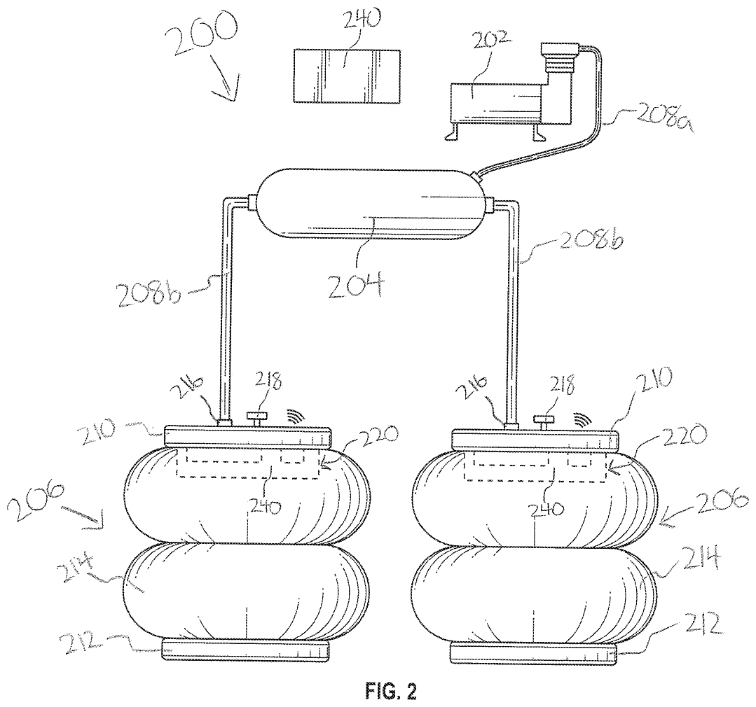

FIG. 2 illustrates a pneumatic air management system 200 according to one configuration of the present invention. Similar to the air management system 100 shown in FIG. 1, the air management system 200 comprises an air source 202, an air supply tank 204, a plurality of air springs 206, and a series of hoses 208a and 208b connecting the air source 202 and the air springs 206 to the air supply tank 204. The air management system 200 further comprises a system controller 240 that is operatively linked to the air springs 206. The system controller 240 allows the pneumatic air management system 200 to selectively supply air to or remove air from each air spring 206 of the air management system 200.

As shown in FIG. 6, the system controller 240 comprises a processing module 242 that may consist of one or more processors, central processing units, application-specific integrated circuits, microprocessors, digital signal processors, microcontrollers or microcomputers. The system controller 240 comprises memory 244, such as read-only memory or random-access memory, to store all necessary software that embodies the control strategy and mathematical formulations for the operation of the system controller. The system controller 240 comprises a communication interface 246 for relaying signals to, from, and between the processing module 242 and the control units of other air springs 206 of the air management system 200 and/or other vehicle operating systems. The system controller 240 comprises a bus 248 that couples the various components of the system controller to the processing module 242. Accordingly, the system controller 240 is configured to receive all the necessary inputs to calculate a desired air pressure for each air spring 206 of the air management system, determine the necessary air flow rate to alter the air pressure of each air spring 206 of the air management system 200, and convey commands in terms of supplying or purging air to the control unit 220 of each air spring 206 of the air management system 200.

Similar to the air springs 106 shown in FIG. 1, each air spring 206 shown in FIG. 2 comprises a top plate 210 configured to be secured to a frame of a vehicle chassis, a base plate 212 configured to be secured to a vehicle axle, and a bellow wall 214 extending from the top plate 210 to the base plate 212. The air spring 206 comprises a fitting 216 disposed in the top plate 210 and projecting away from a first surface of the top plate 210. The fitting 216 is configured to connected to the air spring line 208b so that air may enter into the chamber of the air spring 206, thereby increasing the air pressure of the air spring 206. The air spring 206 comprises an air exhaust port 218 disposed in the top plate 210 and projecting away from the top surface of the top plate 210. The air exhaust port 218 is configured to release air from the chamber of the air spring 206 to the atmosphere, thereby reducing the air pressure of the air spring 206.

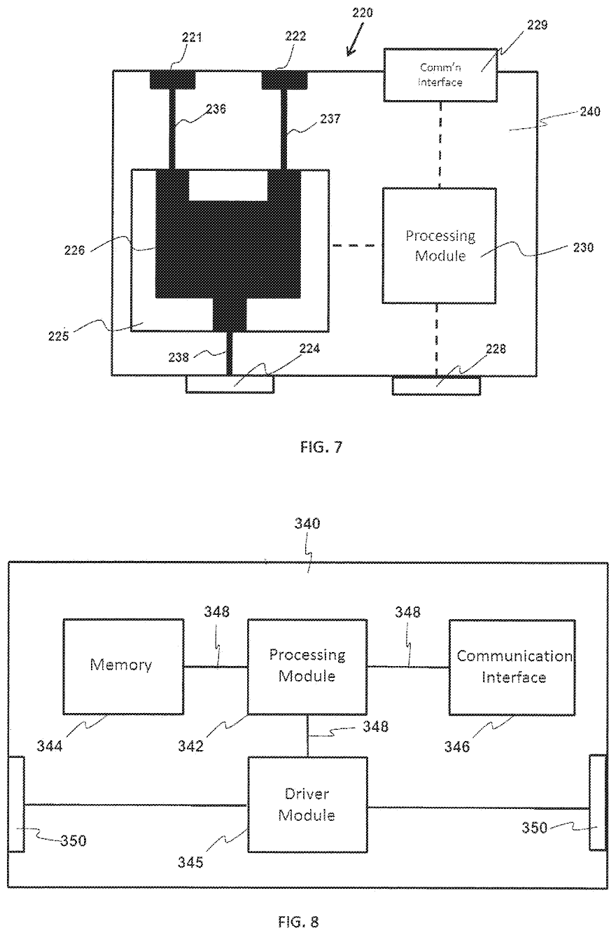

A control unit 220 is disposed within the chamber of each air spring 206 and comprises a housing 240 mounted to an interior surface of the top plate 210. Similar to the control unit shown in FIG. 5, the control unit 220 shown in FIG. 7 comprises an inlet port 221 disposed along a first surface of the housing 240, an outlet port 222 disposed along the first surface of the housing 240, a delivery port 224 disposed along a second surface of the housing 240, a valve 226 disposed in a valve chamber 225, one or more sensors 228, a communication interface 229, and a processing module 230 operatively linked to the one or more sensors and the communication interface. The control unit 220 differs from the control unit 120 shown in FIG. 5 in that the communication interface 229 comprises an antenna that is configured to communicate wirelessly to the system controller 240.

The system controller 240 and the control units 220 are linked together to operates as a closed-loop control system to adjust the height of each air spring to a desired height based on the monitored operating conditions of the vehicle. In operation, each control unit 220 transmits signals indicating the spring height and the internal air pressure of its associated air spring to the system controller 240. In return, the system controller 240 determines the desired air pressure and the desired volumetric flow rate to remove and supply air to and from each air spring 206 based on the signals received from the control units 220. In determining the desired air pressure for each air spring 206, the system controller 240 may take into account the differences in air pressures and spring heights between all the air springs of the air management system. After determining the desired air pressure and flow rate for each air spring 206, the system controller 240 transmits commands to the control unit of each air spring of the pneumatic air management system, in which the command includes the desired flow rate for supplying or removing air to and from the air springs 206. Once receiving a command to supply or purge air at a desired flow rate, each control unit 220 actuates the valve 226 to initiate the supply or removal of air from its associated air spring 206.

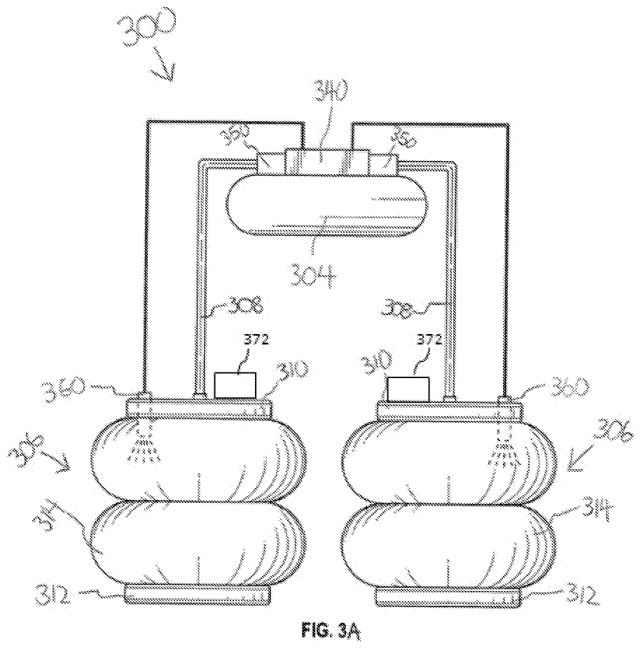

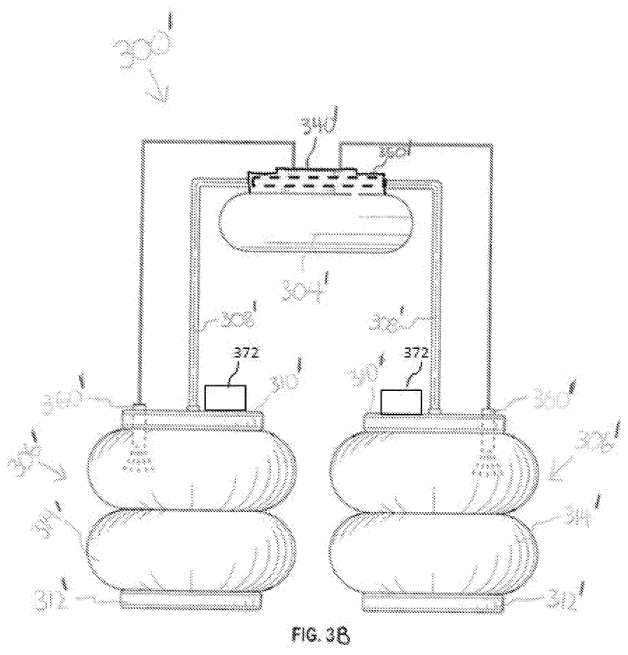

FIG. 3A illustrates a pneumatic air management system 300 according to one configuration of the present invention. Similar to the pneumatic air management system 100 shown in FIG. 1, the pneumatic air management system 300 comprises an air supply tank 304, a plurality of air springs 306, and a series of hoses 308 connecting the air supply tank 304 to the air springs 306. The pneumatic air management system 300 further comprises a system controller 340 and a plurality of valves 350 operatively linked to the system controller 340. The system controller 340 allows the pneumatic air management system 300 to selectively supply air to or remove air from each air spring 306 of the pneumatic air management system 300 by actuating the plurality of valves 350.

Similar to the air springs 106 shown in FIG. 1, each air spring 306 shown in FIG. 3 comprises a top plate 310 configured to be secured to a frame of a vehicle chassis, a base plate 312 configured to be secured to a vehicle axle, and a bellow wall 314 extending from the top plate 310 to the base plate 312. A height sensor 360 is disposed in the top plate 310 of each air spring 306 and is configured to continuously monitor the height of its associated air spring. The height sensor 360 may be any suitable device for monitoring the axial height of the air spring, such as the examples described above. Each height sensor 360 is wired to the system controller 340 so that each height sensor 360 may transmit signals indicating the height of its associated air spring 306 to the system controller 340. An inertial sensor unit 372 is optionally disposed on the top plate 310 of each air spring 306. The inertial sensor unit 372 may include the same type of sensors as the aspect described in FIG. 17, which includes an accelerometer, a gyroscope, and a magnetometer.

Similar to the system controller shown in FIG. 6, the system controller 340 shown in FIG. 8 comprises a processing module 342 for determining the desired air pressure and flow rate for each air spring 306 of the pneumatic air management system 300, a communication interface 346 for relaying signals to and from the processing module 342 and the height sensors of the air springs 306, a memory 344 for storing all necessary software that embodies the control strategy and mathematical formulations for the operation of the system controller 340, and a bus 348 connecting the communication interface and memory to the processing module. The system controller 340 further comprises a driver module 345, such as a driving circuit, operatively linking the processing module 342 to each valve 350 such that the system controller 340 may selectively actuate each valve 350 independently.

The processing module of the system controller may signal the driver module to actuate the valve in any suitable manner, such as by pulse width modulation or hit-and-hold actuation. Accordingly, the system controller 340 is configured to receive all the necessary inputs to calculate a desired air pressure for each air spring of the pneumatic air management system 300, determine the necessary air flow rate to alter the air pressure of each air spring 306 of the pneumatic air management system 300, and actuate at least one of the valves 350 to adjust the air pressure and height of at least one of the springs 306 of the pneumatic air management system 300.

The system controller 340 and the height sensors 360 are linked together to operates as a closed-loop control system to adjust the height of each air spring to a desired height based on the monitored operating conditions of the vehicle. In operation, the system controller 340 receives signals indicating the spring height of its associated air spring 306 from the height sensor 360 of each air spring 306. The system controller 340 determines the desired air pressure for the air spring based on inputs from the sensors of system 300. In determining the desired air pressure for each air spring, the system controller may take into account the differences in air pressures between all the air springs of the pneumatic air management system. The system controller further determines the volumetric flow rate for removing or supplying air from each air spring 306 of the pneumatic air management system 300. After determining the desired air pressure and flow rate for each air spring 306, the system controller 340 actuates each valve 350 to initiate the supply or removal of air from its associated air spring 306.

FIG. 3B illustrates an air management system 300′ according to one configuration of the present invention. The air management system 300′ is similar to the air management system 300 of FIG. 3A and has analogous components except that the system controller 340′ comprises a single valve 350′ that is pneumatically connected to each air spring 306′ of the air management system 300′. Accordingly, the system controller 340′ may selectively supply or remove air from the air springs 306′ through the use of only one valve 350′.

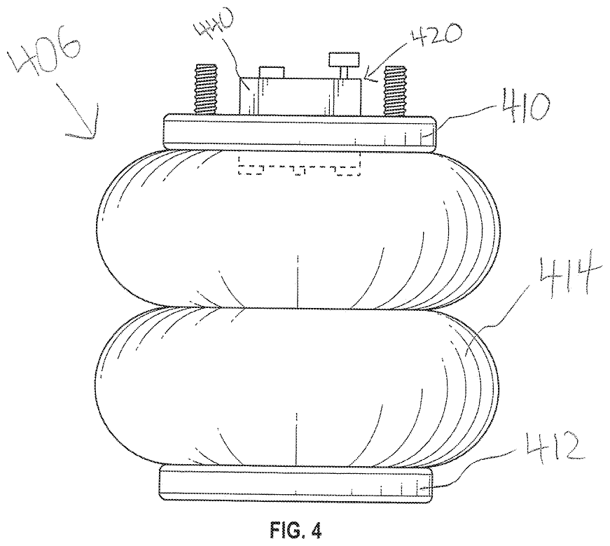

FIG. 4 illustrates an air spring according to a configuration of the present invention. Similar to the air springs 106 shown in FIG. 1, the air spring 406 shown in FIG. 4 comprises a top plate 410 configured to be secured to a frame of a vehicle chassis, a base plate 412 configured to be secured to a vehicle axle, and a bellow wall 414 extending from the top plate 410 to the base plate 412. A control unit 420 is disposed in the top plate 410 of the air spring and comprises a housing 440 mounted to an exterior surface of the top plate 410. Similar to the control unit 120 shown in FIG. 5, the control unit 420 comprises a delivery port, an inlet port, an outlet port, a valve chamber, a valve disposed in the valve chamber, one or more sensors, a communication interface, and a processing module operatively linked to the one or more sensors and the communication interface. The control unit 420 differs from the control unit 120 shown in FIG. 1 in that the inlet port, the outlet port, the valve, the communication interface, and the processing module are disposed outside the air spring 406. Accordingly, one may have access to service any of the components disposed in the housing of the control unit 420 for repair or to replace the control unit entirely. The housing 440 of the control unit 420 extends into the chamber of the air spring 406 such that the one or more sensors and the delivery port are disposed in the chamber of the air spring 406. The communication interface of the control unit is configured to communicate wirelessly to control units of other air springs or any other vehicle operating system.

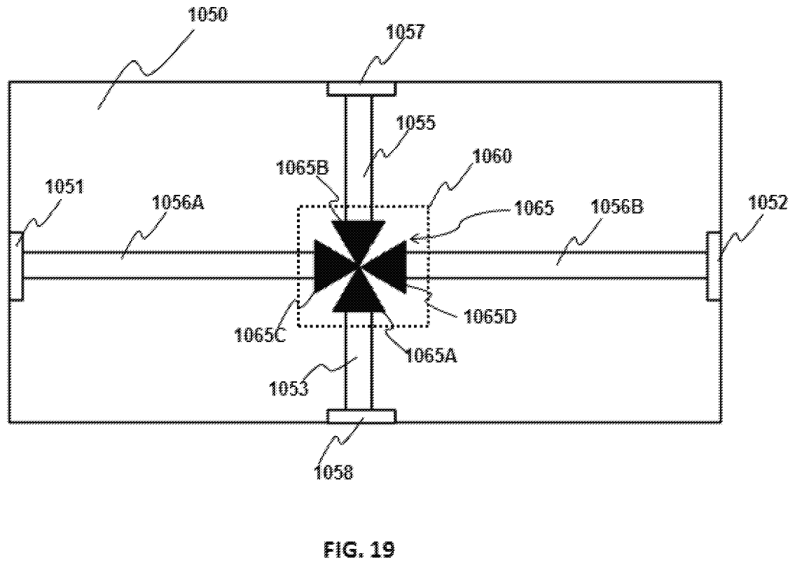

FIG. 10 shows an air management system 1000 comprising a supply air tank 1004, one or more air springs 1030 disposed on a first side 1010 of the vehicle, and one or more air springs 1030 disposed on a second side 1020 of the vehicle. In one example, the air management system 1000 includes an air compressor 1005 located within the air tank 1004 and configured to generate air pressure such that the air tank 1004 can supply air to the first and second air spring 1010, 1020. In other examples, the air management system 1000 includes an air compressor disposed outside the air tank 1004 and connected to the air tank 1004 via a hose. The air management system 1000 further comprises a system controller 1040 comprising a manifold housing 1050 integrally attached to the supply air tank 1004, a valve unit 1060 disposed in the manifold housing 1050, and a printed circuit board 1041 secured to a top side of the manifold housing 1050. As illustrated in FIG. 19 and described in more detail herein, the manifold housing 1050 comprises a plurality of ports and passages to establish communication between the supply tank 1004, the air springs 1010, 1020, and the atmosphere, and the valve unit 1060 comprises a plurality of valves configured to selectively supply air from the air tank 1004 or remove air to the atmosphere for each of the first and second air springs 1010, 1020. The system controller 1040 is configured to selectively supply air to or remove air from each air spring 1010, 1020 of the air management system 1000 by actuating the plurality of valves in the valve unit 1060.

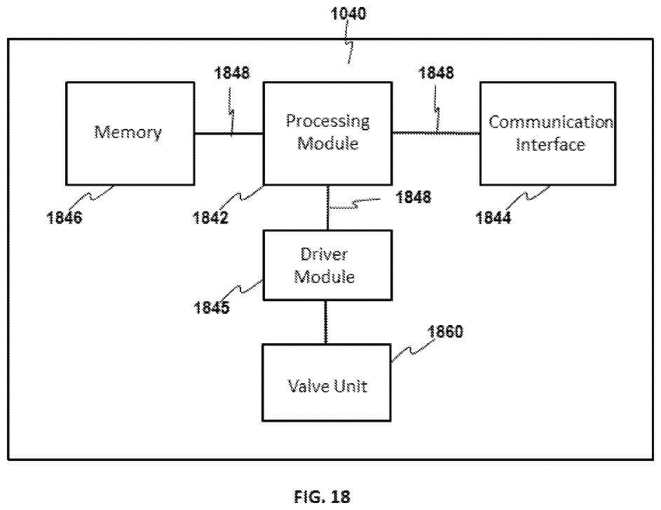

A non-limiting example of the manifold housing 1050 and the valve unit 1060 is further described in FIG. 18. Referring to FIG. 19, the manifold housing 1050 includes a first port 1051 connected to the first pneumatic circuit 1010, a second port 1052 connected to the second pneumatic circuit 1020, an exhaust port 1057 configured to exhaust air into the atmosphere, and a tank port 1058 configured to supply air from the air tank 1004. The manifold housing 1050 further comprises a supply passage 1053 pneumatically connecting the tank port 1058 to the valve unit 1060, an exhaust passage 1055 pneumatically connecting the exhaust port 1057 to the valve unit 1060, a first flow passage 1056A pneumatically connecting the valve unit 1060 with the first port 1051, and a second flow passage 1056B pneumatically connecting the valve unit 1060 with the second port 1052. In some examples, the manifold housing 1050 is formed from aluminum metal.

As shown in FIG. 19, the valve unit is a four-way valve 1065 that includes a first flow valve 1065A, a second flow valve 1065B, a third flow valve 1065C, and a fourth flow valve 1065D disposed at an intersection between the supply passage 1053, exhaust passage 1055, the first flow passage 1056A, and the second flow passage 1056B. In one example, each of the flow valves 1065A-D is a solenoid valve, and each is configured to switch between multiple positions to selectively establish pneumatic communication between any one of the supply tank 1004 and the exhaust port 1057 and any one of the one or more air springs 1030 disposed on the first and second sides 1010, 1020 of the vehicle.

In one example, the first, second, third, and fourth flow valves 1065A-D are synced to operate under a plurality of modes such that the four-wave valve 1065 may selectively establish pneumatic communication between any one of the supply tank 1004 or the exhaust port 1057 and any one of the one or more air springs 1030 disposed on the first and second sides 1010, 1020 of the vehicle. The plurality of modes include a closed mode, in which the flow valves 1065A-D are closed, so that air is not transferred between any one of the supply tank 1004 or the exhaust port 1057 and any one of the air springs 1030.

The plurality of modes include a first inflate mode, in which air is supplied only to the one or more air springs 1030 disposed on the first side 1010 of the vehicle without any air flow to or from to the one or more air springs 1030 disposed on the second side 1020 of the vehicle. At the first inflate mode, the first and third flow valves 1065A, 1065C are switched to a position establishing communication between the supply passage 1053 and the first flow passage 1056A, while the second and fourth flow valves 1065B, 1065D are closed. The plurality of modes include a second inflate mode, in which air is supplied only to the one or more air springs 1030 disposed on the second side 1020 of the vehicle without any air flow to or from the one or more air springs 1030 disposed on the first side 1010 of the vehicle. At the second inflate mode, the first and fourth flow valves 1065A, 1065D are switched to a position establishing communication between the supply passage 1053 and the second flow passage 1056B, while the second and third flow valves 1065B, 1065C are closed. The plurality of modes include a third inflate mode, in which air is supplied to the air springs 1030 on both the first and second sides 1010, 1020 of the vehicle. At the third inflate mode, the first, third, and fourth flow valves 1065A, 1065C, and 1065D are switched to a position establishing communication between the supply passage 1053B and the first and second flow passages 1056A, 1056B, while the second flow valve 1065B is closed.

The plurality of modes includes a first purge mode, in which air is removed only from the one or more air springs 1030 disposed on the first side 1010 of the vehicle without any air flow to or from the one or more air springs 1030 disposed on the second side 1020 of the vehicle. At the first purge mode, the second and third flow valves 1065B, 1065C are switched to a position establishing communication between the exhaust passage 1055 B and the first flow passage 1056A, while the first and fourth flow valves 1065A, 1065D are closed. The plurality of modes includes a second purge mode, in which air is removed only from the one or more air springs 1030 disposed on the second side 1020 of the vehicle without any air flow to or from the one or more air springs 1030 disposed on the first side 1010 of the vehicle. At the second purge mode, the second and fourth flow valves 1065B, 1065D are switched to a position establishing communication between the exhaust passage 1055 and the second flow passage 1056B, while the first and third flow valves 1065A, 1065C are closed. The plurality of modes includes a dump mode, in which air is removed from both the air springs 1030 on both the first and second sides 1010, 1020 of the vehicle. At the dump mode, the second, third, and fourth flow valves 1065B-D are switched to a position establishing communication between the exhaust passage 1055 and the first and second flow passages 1056A, 1056B, while the first flow valve 1065A is closed.

The plurality of modes includes a first combination mode, in which air is removed from the one or more air springs 1030 on the first side 1010 of the vehicle and air is supplied to the one or more air springs 1030 on the second side 1020 of the vehicle. At the first combination mode, the second and third flow valves 1065B, 1065C are switched to a position establishing communication between the exhaust passage 1055 and the first flow passage 1056A, while the first and fourth flow valves 1065A, 1065D are switched to a position establishing communication between the supply passage 1053 and the second flow passage 1056B. The plurality of modes includes a second combination mode, in which air is removed from one or more air springs 1030 on the second side 1020 of the vehicle and air is supplied to one or more air springs 1030 on the first side 1010 of the vehicle. At the second combination mode, the second and fourth flow valves 1065B, 1065D are switched to a position establishing communication between the exhaust passage 1055B and the second flow passage 1056B, while the first and third flow valves 1065A, 1065C are switched to a position establishing communication between the supply passage 1053 and the flow passage 1056B.

Referring to FIG. 10, a height sensor 1070 is disposed in the top plate 1032 of each air spring 1030 and is configured to continuously monitor the height of its associated air spring 1030. The height sensor 1070 may be any suitable device for monitoring the axial height of the air spring, such as the examples described above. Each height sensor 1070 is wired to the system controller 1040 so that each height sensor 1070 may transmit signals indicating the height of its associated air spring 1030 to the system controller 1040. In one example, the height sensor 1070 is wired to the printed circuit board 1041 such that the processing module 1042 of the system controller 1040 receives inputs from the height sensor 1070 via the communication interface 1044. In other, non-limiting examples, the height sensor 1070 may be wirelessly connected to the system controller 1040 such that the communication interface 1044 receives wireless signals from the height sensor 1070.

Referring to FIG. 10, an inertial sensor unit 1072 is optionally disposed on the top plate 1032 of each air spring 1030. The inertial sensor unit 1072 may include the same type of sensors as the aspect described in FIG. 17, which includes an accelerometer, a gyroscope, and a magnetometer. Each inertial sensor unit 1072 may transmit signals indicating the acceleration, angular velocity, and the magnetic force with respect to one or more axes of the vehicle to the system controller 1040. In some examples, the inertial sensor unit 1072 is wired to the system controller 1040 such that the inertial sensor unit 1072 transmits signals along a cable. In some examples, the inertial sensor unit 1072 transmits signals wirelessly to the system controller 1040.

Similar to the example described in FIG. 8, the system controller 1040 of FIG. 18 comprises a printed-circuit-board that includes a processing module 1042 for determining the desired air pressure and flow rate for each air spring 1030 of the air management system 1000, a communication interface 1844 for relaying signals to and from the processing module and the height sensors of the air springs 1030, a memory 1846 for storing all necessary software that embodies the control strategy and mathematical formulations for the operation of the system controller 1040, and a bus 1848 connecting the communication interface 1844 and memory 1846 to the processing module 1842. As shown in FIG. 18, the system controller 1040 further comprises a driver module 1845, such as a driving circuit, operatively linking the processing module 1842 to each valve of the valve unit 1860 such that the system controller 1040 may selectively actuate each respective valve. The processing module 1842 of the system controller 1040 may signal the driver module 1845 to actuate the respective valve in any suitable manner, such as by pulse width modulation or hit-and-hold actuation. Accordingly, the system controller 1040 is configured to receive all the necessary inputs to calculate a desired air pressure for each air spring of the air management system 1000, determine the necessary air flow rate to alter the air pressure of each air spring 1030 of the air management system 1000, and actuate at least one of the valves to adjust the air pressure and height of at least one of the springs 1030 of the air management system 1000.

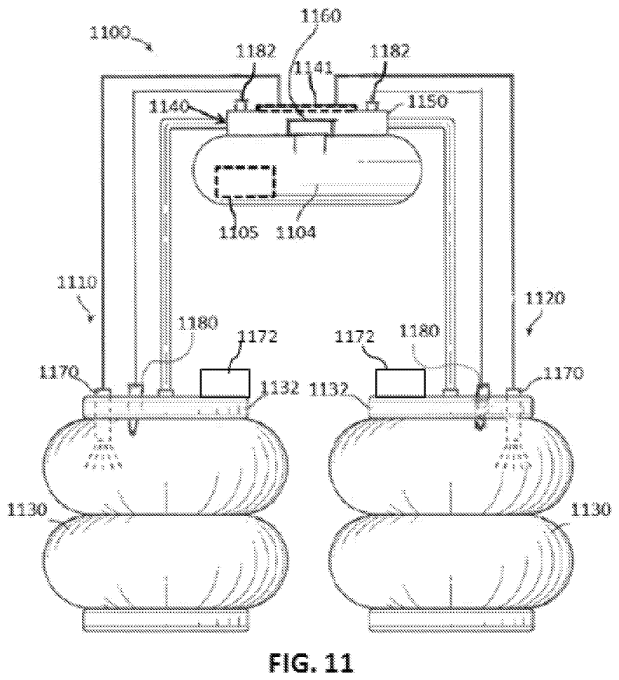

FIG. 11 shows an air management system 1100 comprising a supply air tank 1104, one or more air springs 1130 disposed on a first side 1110 of the vehicle, and one or more air springs 1130 disposed on a second side 1120 of the vehicle. In one example, the air management system 1100 includes an air compressor 1105 located within the air tank 1104 and configured to generate air pressure such that the air tank 1104 can supply air to the first and second air springs 1110, 1120. In such a configuration, the air management system 1100 provides further advantages in terms of compact design, protection from environmental elements, and significant noise reduction allowing the air management system to be used in any type of vehicle. Accordingly, the present disclosure provides a method of reducing noise, protecting system components and increasing longevity, and providing universal installation capabilities to the air management system.

When the air compressor 1105 is located in the air tank 1104, the air compressor 1105 may be rigidly installed in the air tank 1104 so as to reduce, inhibit or prevent noise and vibrations of the compressor and avoid damage to the compressor, tank, valves, lines, and other air management system 1100 components from dynamic driving vibrations and impacts. For example, a movement-resistant (fixed) installation is performed using brackets, braces, rods, longitudinal frame rails, fasteners, interlocking mounting members on the outer surface of the air compressor 1105 and on the inner surface the air tank 1104.

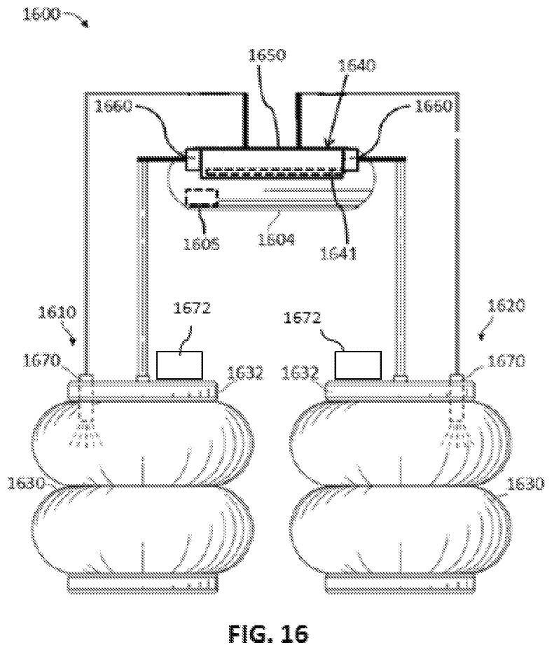

In other examples, the air management system 1100 includes an air compressor disposed outside the air tank 1104 and connected to the air tank 1104 via a hose. Similar to the example described in FIG. 10, the air management system 1100 further comprises a system controller 1140 comprising a manifold housing 1150 integrally attached to the supply air tank 1104, a valve unit 1160 disposed in the manifold housing 1150, and a printed circuit board 1141 secured to a top side of the manifold housing 1150. The manifold housing 1150 comprises a plurality of ports and passages to establish communication between the supply tank 1104, the air springs 1110, 1120, and the atmosphere, and the valve unit 1160 comprises a plurality of valves configured to selectively supply air from the air tank 1104 or remove air to the atmosphere for each of the first and second air springs 1110, 1120. Similar to the examples described in FIGS. 10 and 16, the system controller 1140 is configured to selectively supply air to or remove air from each air spring 1130 of the air management system 1100 by actuating the plurality of valves in the valve unit 1160.

Referring to FIG. 11, the air management system 1100 further comprises a height sensor 1170, a first proportional control sensor 1180 disposed in the top plate 1132 of each air spring 1130, and second proportional control sensors 1182 disposed in the manifold housing 1150. The height sensor 1170 is configured to continuously monitor the height of its associated air spring 1130 and relay signals indicating the height of the air spring 1130 to the system controller 1140. The first proportional control sensor 1180 is configured to monitor the air pressure of its associated air spring 1130 and relay signals indicating the air pressure of the air spring 1130 to the system controller 1140. The second proportional sensor 1182 is configured to measure the air pressure of a respective port (e.g., first port 1051, second port 1052) connected to one of its associated air springs 1130. Accordingly, the system controller 1140 may calculate the height of the air springs 1130 based on signals received from the height sensor 1170, and then, determine the desired air pressure for each associated air spring 1030 based on calculated heights and the desired flow rate needed to adjust the air spring 1030 to provide optimal stability and comfort for the vehicle. Then, the controller 1140 transmits commands to the valve unit 1160, thereby selectively actuating the individual valves to provide the desired flow rate to each air spring 1130. After actuating the valves of the valve unit 1160, the system controller 1140 may receive signals from the first and second proportional control sensors 1180, 1182 to determine the altered air pressure of the air springs 1130. Thus, the proportional control sensors 1180, 1182 provide feedback to the system controller 1140 so that the system controller 1140 can determine the lag time for air to travel between the valve unit 1160 and each air spring 1130 based on signals received from the proportional control sensor 1180.

Referring to FIG. 11, an inertial sensor unit 1172 is optionally disposed on the top plate 1132 of each air spring 1130. The inertial sensor unit 1172 may include the same type of sensors as the aspect described in FIG. 17, which includes an accelerometer, a gyroscope, and a magnetometer. Each inertial sensor unit 1172 may transmit signals indicating the acceleration, angular velocity, and the magnetic force with respect to one or more axes of the vehicle to the system controller 1140. In some examples, the inertial sensor unit 1172 is wired to the system controller 1140 such that the inertial sensor unit 1172 transmits signals along a cable. In some examples, the inertial sensor unit 1172 transmits signals wirelessly to the system controller 1140.

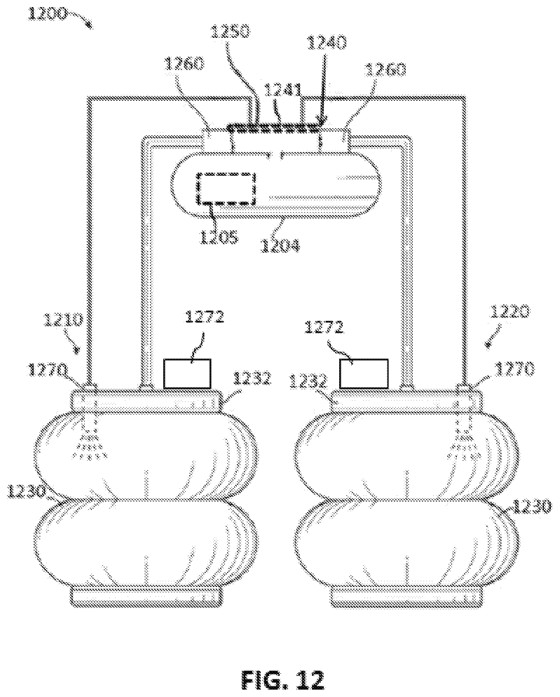

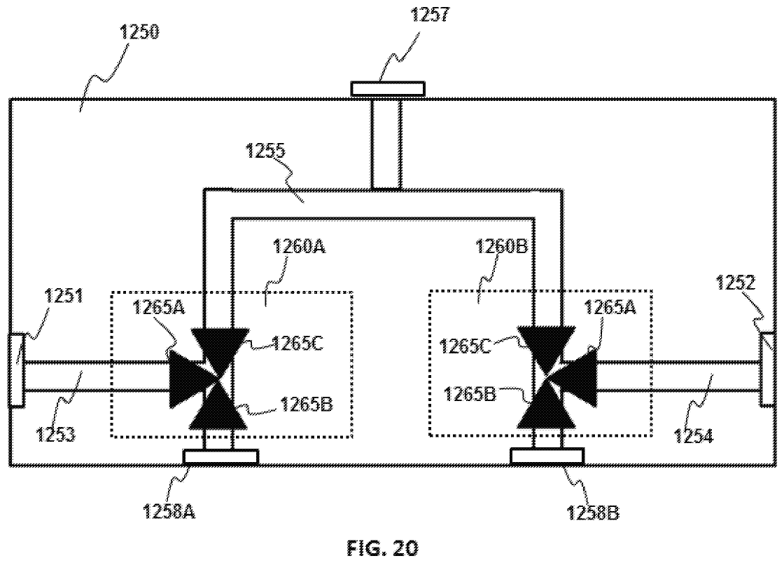

FIG. 12 shows an air management system 1200 comprising a supply air tank 1204, one or more air springs 1230 disposed on a first side 1210 of the vehicle, and one or more air springs 1230 disposed on a second side 1220 of the vehicle. Each pneumatic circuit 1210, 1220 includes one or more air springs 1230. In one example, the air management system 1200 includes an air compressor 1205 located within the air tank 1204 and configured to generate air pressure such that the air tank 1204 can supply air to the first and second pneumatic circuits 1210, 1220. In other examples, the air management system 1200 includes an air compressor disposed outside the air tank 1204 and connected to the air tank 1204 via a hose. The air management system 1200 further comprises a system controller 1240 comprising a manifold housing 1250 integrally attached to the supply air tank 1204, a pair of leveling valves 1260 disposed at each end of the manifold housing 1250, and a printed circuit board 1241 secured to the top side of the manifold housing 1250. As will be described in more detail in FIG. 20, the manifold housing 1250 comprises a plurality of ports and passages to establish communication between the supply tank 1204, the pneumatic circuits 1210, 1220, and the atmosphere.

In some examples, the leveling valves 1260 is one of a rotary valve, a solenoid valve, and a poppet valve, whereby each leveling valve 1260 is electronically actuated by the system controller to manipulate air flow through the housing 1250. Each leveling valve 1260 is configured to selectively supply air from the air tank 1204 to the one or more air springs 1230 on its associated side of the vehicle or remove air from the one or more air springs 1230 on its associated side of the vehicle to the atmosphere. Similar to the examples described in FIGS. 10 and 11, the system controller 1240 is configured to selectively supply air to or remove air from each air spring 1230 of the air management system 1200 by actuating the valves 1260.

One non-limiting example of the manifold housing 1250 and the leveling valves 1260 are further described in FIG. 20. Similar to the example described in FIG. 19, the manifold housing 1250 includes a first port 1251 pneumatically connected to the one or more air springs 1230 disposed on the first side 1210 of the vehicle, a second port 1252 pneumatically connected to the one or more air springs 1230 disposed on the second side 1220 of the vehicle, an exhaust port 1257 configured to exhaust air into the atmosphere. Rather, than having a single tank port, the exemplary manifold housing shown in FIG. 20 includes first and second tank ports 1258a, 1258b configured to supply air from the air tank 1204. The manifold housing 1250 further comprises a first passage 1253 connecting the first tank port 1258A to the first port 1251 and a second passage 1254 connecting the second tank port 1258B to the second port 1252. The manifold housing 1250 further comprises an exhaust passage 1255 connected to both the first and second passages 1253, 1254.

In the illustrated example shown in FIG. 20, the leveling valves 1260 include a first leveling valve 1260A connected to the first passage 1253 and a second leveling valve 1260B connected to the second passage 1254. In the illustrated example, each leveling valve 1260A, 1260B is a three-way valve that includes a first flow valve 1265A, a second flow valve 1265B, and a third flow valve 1265C disposed at an intersection between the one of the first and second passages 1253, 1254 and the exhaust passage 1255. In one example, each of the flow valves 1265A-C is a solenoid valve, and each is configured to switch between multiple positions to selectively establish pneumatic communication between any one of the supply tank 1204 and the exhaust port 1257 and any one of the one or more air springs 1030 disposed on the first and second sides 1210, 1220 of the vehicle.

In one example, the first, second, and third flow valves 1265A-C are synced to operate under a plurality of modes such that each leveling valve 1260A, 1260B may selectively establish pneumatic communication between any one of the supply tank 1204 or the exhaust port 1257 and any one of the one or more air springs 1230 disposed on the leveling valve's associated side of the vehicle. The plurality of modes include a closed mode, in which the all the flow valves 1265A-C are closed, so that air is not transferred between any one of the supply tank 1204 or the exhaust port 1257 and any one of the air springs 1230.

The plurality of modes include an inflate mode, in which air is supplied to the one or more air springs 1230 disposed on the leveling valve's associated side of the vehicle. At the inflate mode, the first and second flow valves 1265A, 1265B are switched to a position establishing communication between the respective passage 1253, 1254 and the respective tank port 1258A, 1258B, while the third flow valve 1265C is closed.

The plurality of modes include a deflate mode, in which air is removed from the one or more air springs 1230 disposed on the leveling valve's associated side of the vehicle. At the deflate mode, the first and third flow valves 1265A, 1265C are switched to a position establishing communication between the respective passage 1253, 1254 and the exhaust passage 1255, while the second flow valve 1265B is closed.

Referring to FIG. 12, an inertial sensor unit 1272 is optionally disposed on the top plate 1232 of each air spring 1230. The inertial sensor unit 1272 may include the same type of sensors as the aspect described in FIG. 17, which includes an accelerometer, a gyroscope, and a magnetometer. Each inertial sensor unit 1272 may transmit signals indicating the acceleration, angular velocity, and the magnetic force with respect to one or more axes of the vehicle to the system controller 1240. In some examples, the inertial sensor unit 1272 is wired to the system controller 1240 such that the inertial sensor unit 1272 transmits signals along a cable. In some examples, the inertial sensor unit 1272 transmits signals wirelessly to the system controller 1240.

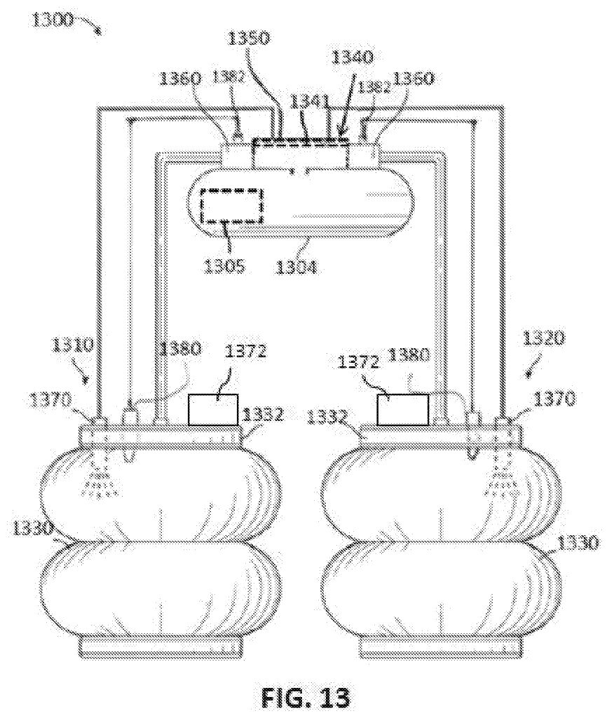

FIG. 13 shows an air management system 1300 comprising a supply air tank 1304, one or more air springs 1330 disposed on a first side 1310 of the vehicle, and one or more air springs 1330 disposed on a second side 1320 of the vehicle. In one example, the air management system 1300 includes an air compressor 1305 located within the air tank 1304 and configured to generate air pressure such that the air tank 1304 can supply air to the first and second air springs 1310, 1320. In other examples, the air management system 1300 includes an air compressor disposed outside the air tank 1304 and connected to the air tank 1304 via a hose. Similar to the examples described in FIG. 3A, the air management system 1300 comprises a system controller 1340 comprising a manifold housing 1350 integrally attached to the supply air tank 1304, a pair of valves 1360 disposed at each end of the manifold housing 1350, and a printed circuit board 1341 secured to a top side of the manifold housing 1350. Similar to the example described in FIG. 20, the manifold housing 1350 comprises a plurality of ports and passages to establish communication between the supply tank 1304, the air springs 1310, 1320, and the atmosphere, and each valve 1360 is configured to selectively supply air from the air tank 1304 or remove air to the atmosphere for each of the first and second air spring 1310, 1320. Similar to the examples described in FIGS. 12 and 18, the system controller 1340 is configured to selectively supply air to or remove air from each air spring 1330 of the air management system 1300 by actuating the valves 1360.

Similar to the example illustrated in FIG. 11 and described in this disclosure, the air management system 1300 of FIG. 13 further comprises a height sensor 1370, a first proportional control sensor 1380 disposed in the top plate 1332 of each air spring 1330, and second proportional control sensors 1382 disposed in the manifold housing 1350. Accordingly, similar to the example described in FIG. 11, the system controller 1340 may proportionally control the height of the air springs 1330 based on signals received from the height sensor 1370 and proportional control sensor 1380.

Referring to FIG. 13, an inertial sensor unit 1372 is optionally disposed on the top plate 1332 of each air spring 1330. The inertial sensor unit 1372 may include the same type of sensors as the aspect described in FIG. 17, which includes an accelerometer, a gyroscope, and a magnetometer. Each inertial sensor unit 1372 may transmit signals indicating the acceleration, angular velocity, and the magnetic force with respect to one or more axes of the vehicle to the system controller 1340. In some examples, the inertial sensor unit 1372 is wired to the system controller 1340 such that the inertial sensor unit 1372 transmits signals along a cable. In some examples, the inertial sensor unit 1372 transmits signals wirelessly to the system controller 1340.

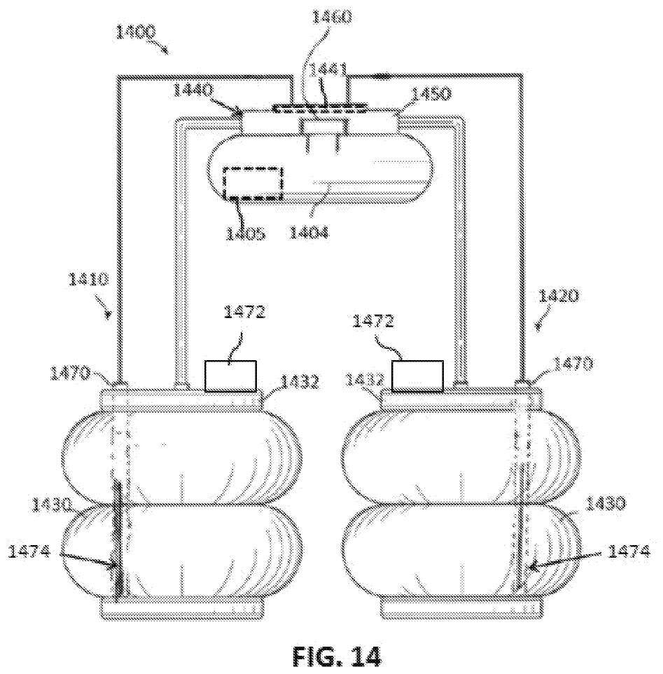

FIG. 14 shows an air management system 1400 comprising a supply air tank 1404, one or more air springs 1430 disposed on a first side 1410 of the vehicle, and one or more air springs 1430 disposed on a second side 1420 of the vehicle. In one example, the air management system 1400 includes an air compressor 1405 located within the air tank 1404 and configured to generate air pressure such that the air tank 1404 can supply air to the first and second air springs 1410, 1420. In other examples, the air management system 1400 includes an air compressor disposed outside the air tank 1404 and connected to the air tank 1404 via a hose. Similar to the examples described in FIGS. 10 and 11, the air management system 1400 further comprises a system controller 1440 comprising a manifold housing 1450 integrally attached to the supply air tank 1404, a valve unit 1460 disposed in the manifold housing 1450, and a printed circuit board 1441 secured to the top side of the manifold housing 1450. Similar to the example described in FIG. 16, the manifold housing 1450 comprises a plurality of ports and passages to establish communication between the supply tank 1404, the air springs 1410, 1420, and the atmosphere, and the valve unit 1460 comprises a plurality of valves configured to selectively supply air from the air tank 1404 or remove air to the atmosphere for each of the first and second air springs 1410, 1420. Similar to the examples described in FIGS. 10 and 18, the system controller 1440 is configured to selectively supply air to or remove air from each air spring 1430 of the air management system 1400 by actuating the plurality of valves in the valve unit 1460.

As shown in FIG. 14, the air management system 1400 comprises a height sensor 1470 disposed in the top plate 1432 of each air spring 1430, in which the height sensor 1470 is a linear potentiometer sensor configured to monitor the height of its associated air spring 1430. Referring to FIG. 14, the height sensor 1470 comprises a linear shaft 1474 that extends along the height of its associated air spring 1430 and configured to move up and down as the air spring 1430 expands or contracts. The height sensor 1470 further comprises a wiper contact (not shown) electrically linked to a mechanical shaft 1472, and the resistance value between the wiper contact and the shaft 1472 provide an electrical signal output that is proportional to the height of the air spring 1430. Accordingly, the system controller 1440 may control the height of the air springs 1430 based on signals received from the height sensor 1470.

Referring to FIG. 14, an inertial sensor unit 1472 is optionally disposed on the top plate 1432 of each air spring 1430. The inertial sensor unit 1472 may include the same type of sensors as the aspect described in FIG. 17, which includes an accelerometer, a gyroscope, and a magnetometer. Each inertial sensor unit 1472 may transmit signals indicating the acceleration, angular velocity, and the magnetic force with respect to one or more axes of the vehicle to the system controller 1440. In some examples, the inertial sensor unit 1472 is wired to the system controller 1440 such that the inertial sensor unit 1472 transmits signals along a cable. In some examples, the inertial sensor unit 1472 transmits signals wirelessly to the system controller 1440.

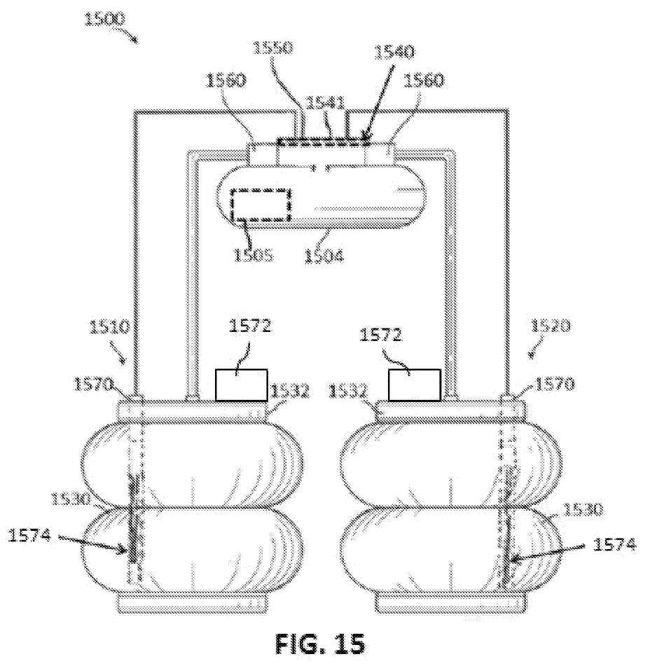

FIG. 15 shows an air management system 1500 comprising a supply air tank 1504, one or more air springs 1530 disposed on a first side 1510 of the vehicle, and one or more air springs 1530 disposed on a second side 1520 of the vehicle. In one example, the air management system 1500 includes an air compressor 1505 located within the air tank 1504 and configured to generate air pressure such that the air tank 1504 can supply air to the first and second air springs 1510, 1520. In other examples, the air management system 1500 includes an air compressor disposed outside the air tank 1504 and connected to the air tank 1504 via a hose. Similar to the example described in FIGS. 12 and 13, the air management system 1500 comprises a system controller 1540 comprising a manifold housing 1550 integrally attached to the supply air tank 1504, a pair of valves 1560 disposed at each end of the manifold housing 1550, and a printed circuit board 1541 secured to a top side of the manifold housing 1550. Similar to the example described in FIG. 20, the manifold housing 1550 comprises a plurality of ports and passages to establish communication between the supply tank 1504, the air springs 1510, 1520, and the atmosphere, and each valve 1560 is configured to selectively supply air from the air tank 1504 or remove air to the atmosphere for each of the first and second air springs 1510, 1520. Similar to the examples described in FIGS. 12 and 18, the system controller 1540 is configured to selectively supply air to or remove air from each air spring 1530 of the air management system 1500 by actuating the valves 1560.

Similar to the example described in FIG. 14, the air management system 1500 comprises a height sensor 1570 disposed in the top plate 1532 of each air spring 1530, in which the height sensor 1570 is a linear potentiometer sensor configured to monitor the height of its associated air spring 1530. Similar to FIG. 14, the height sensor 1570 comprises a linear shaft 1574 that extends along the height of its associated air spring 1530 and configured to move up and down as the air spring 1530 expands or contracts. Accordingly, the system controller 1540 may control the height of the air springs 1530 based on signals received from the height sensor 1570.

Referring to FIG. 15, an inertial sensor unit 1572 is optionally disposed on the top plate 1532 of each air spring 1530. The inertial sensor unit 1572 may include the same type of sensors as the aspect described in FIG. 17, which includes an accelerometer, a gyroscope, and a magnetometer. Each inertial sensor unit 1572 may transmit signals indicating the acceleration, angular velocity, and the magnetic force with respect to one or more axes of the vehicle to the system controller 1540. In some examples, the inertial sensor unit 1572 is wired to the system controller 1540 such that the inertial sensor unit 1572 transmits signals along a cable. In some examples, the inertial sensor unit 1572 transmits signals wirelessly to the system controller 1540.

FIG. 16 shows an air management system 1600 comprising a supply air tank 1604 one or more air springs 1630 disposed on a first side 1610 of the vehicle, and one or more air springs 1630 disposed on a second side 1620 of the vehicle. In one example, the air management system 1600 includes an air compressor 1605 located within the air tank 1604 and configured to generate air pressure such that the air tank 1604 can supply air to the first and second air springs 1610, 1620. In other examples, the air management system 1600 includes an air compressor disposed outside the air tank 1604 and connected to the air tank 1604 via a hose. The air management system 1600 further comprises a system controller 1640 disposed within the air tank 1604. The system controller 1640 comprises a manifold housing 1650 integrally attached to the supply air tank 1604, a pair of leveling valves 1660 disposed at each end of the manifold housing 1650, and a printed circuit board 1641 secured to the top side of the manifold housing 1650. Similar to the aspect described in FIG. 20, the manifold housing 1650 comprises a plurality of ports and passages to establish communication between the supply tank 1604, the air springs 1630 on each side 1610, 1620 of the vehicle, and the atmosphere. Each leveling valve 1660 is configured to selectively supply air from the air tank 1604 to the one or more air springs 1630 disposed on its associated side of the vehicle or remove air from the one or more air springs 1630 disposed on its associated side of the vehicle to the atmosphere. Similar to the examples described in FIGS. 10 and 11, the system controller 1640 is configured to selectively supply air to or remove air from each air spring 1630 of the air management system 1600 by actuating the leveling valves 1660.

Similar to the examples described above, the air management system 1600 comprises a height sensor 1670 disposed in the top plate 1632 of each air spring 1630, in which the height sensor 1670 (e.g., ultrasonic sensor, laser sensor) is configured to monitor the height of its associated air spring 1630. Accordingly, the system controller 1640 may control the height of the air springs 1630 based on signals received from the height sensor 1670. Similar to the examples described above, the air management system 1600 may further comprise a first proportional control sensor (not shown) disposed in the top plate 1632 of each air spring 1630, and second proportional control sensors (not shown) disposed in the manifold housing 1650 so that the system controller may control the height of the air springs 1630 based on signals received from the proportional control sensors.

Referring to FIG. 16, an inertial sensor unit 1672 is optionally disposed on the top plate 1632 of each air spring 1630. The inertial sensor unit 1672 may include the same type of sensors as the aspect described in FIG. 17, which includes an accelerometer, a gyroscope, and a magnetometer. Each inertial sensor unit 1672 may transmit signals indicating the acceleration, angular velocity, and the magnetic force with respect to one or more axes of the vehicle to the system controller 1640. In some examples, the inertial sensor unit 1672 is wired to the system controller 1640 such that the inertial sensor unit 1672 transmits signals along a cable. In some examples, the inertial sensor unit 1672 transmits signals wirelessly to the system controller 1640.

In each configuration of the air management system described in FIGS. 10-20, the air management system may include other types of sensors, such as accelerometers, gyroscopes and magnetometer, and determine the desired air pressure or height for each air spring based on inputs received from the other sensors, including accelerometers, gyroscopes and magnetometer. In one example, an accelerometer includes an electromechanical device configured to measure acceleration forces of the vehicle. In one example, a gyroscope includes a device configured to measure rotation motion of the vehicle, such as angular velocity of the vehicle. Accordingly, input from the accelerometers, gyroscopes and magnetometer may be used to calculate a dynamic vehicle condition (e.g. tilt of vehicle, rolling condition, lateral acceleration etc.), and the system controller may determine the desired air pressure or height of each air spring based on the calculated dynamic vehicle condition.

In each configuration of the air management system described in FIGS. 10-20, the system controller operates as a closed-loop control system to adjust the height of the air springs to a desired height based on the monitored operating conditions of the vehicle. In operation, the system controller receives, by the communication interface, inputs from the one or more sensors, such as the height sensor and the proportional control sensor, to determine the height and the internal air pressure of each air spring. The system controller then determines, by the processing module, the desired air pressure for each air spring based on inputs from the one or more sensors. In determining the desired air pressure for each air spring, the system controller may take into account the differences in air pressures between all the air springs of the air management system so that the system controller may determine the vehicle pitch and roll rates. The system controller determines, by the processing module, the flow rate needed to adjust the internal air pressure of each air spring based on the vehicle roll and pitch rates. In one configuration, the calculated flow rate is based on how fast the height of the air spring is changing in response to a load or displacement (i.e., height differential rate). Based on the height differential rate and the internal pressure of the air springs and the differences between heights of the air springs of the air management system, the system controller is configured to determine the desired air pressure and flow rate needed to adjust each air spring to provide optimal stability and comfort for the vehicle. After determining the desired air pressure and flow rate, the system controller is configured to control the flow rate of air being exhausted from or supplied to each air spring by transmitting, by the driver module, commands to the individual valves.

In each configuration of the air management system shown in FIGS. 10-20, the system controller is configured to equalize the air pressure between at least one air spring of first side of vehicle and at least one air spring of the second side of vehicle when the pressure differential or height differential between the air springs of the first and second sides of the vehicle is within a predetermined threshold. For example, if the system controller receives height measurements from signals transmitted by the height sensors that indicate that the height differential between the air springs of the first and second pneumatic circuits are within a predetermined threshold, the system controller will actuate the valves to equalize the air pressure between at least one air spring of first side of vehicle and at least one other spring of the second side of vehicle. In each configuration of the air management system shown in FIGS. 10-20, the system controller is configured to independently adjust the air pressure of at least one air spring of the first side of vehicle to a first air pressure and at least one air spring of the second side of vehicle to a second air pressure when the pressure differential or height differential between the air springs of the first and second sides of the vehicle is greater than a predetermined threshold. In some examples, the first air pressure is not equal to the second air pressure. The system controller may determine the pressure or height differential of the air springs of each side of the vehicle based on measurement signals received from the sensors described above.

In each configuration of the air management system shown in FIGS. 10-20, the system controller may be disposed in the interior of the supply tank such that the printed-circuit-board, the passages, and the valves are located within the supply tank. In one example, the system controller may be coupled to the interior surface of the supply tank. In one example, the supply tank may include mounting structure, such as brackets or rails to secure the system controller within the supply tank. Accordingly, the system controller may independently adjust air flow to each air spring.

In each configuration of the air management system shown in FIGS. 1-20, the control units or the system controller may be configured to execute a dump cycle such that the air is released from each air spring of the air management system at the same time. In each air management system shown in FIGS. 1-4, the air management system may include a user interface unit operatively linked to the control units or the system controller and configured transmit a command to the system controller or the control units to execute a dump cycle so that air is released from all the air springs. The user interface unit may be disposed in the vehicle dashboard or configured as an application downloaded on a display device, such as a smartphone or hand-held computer.

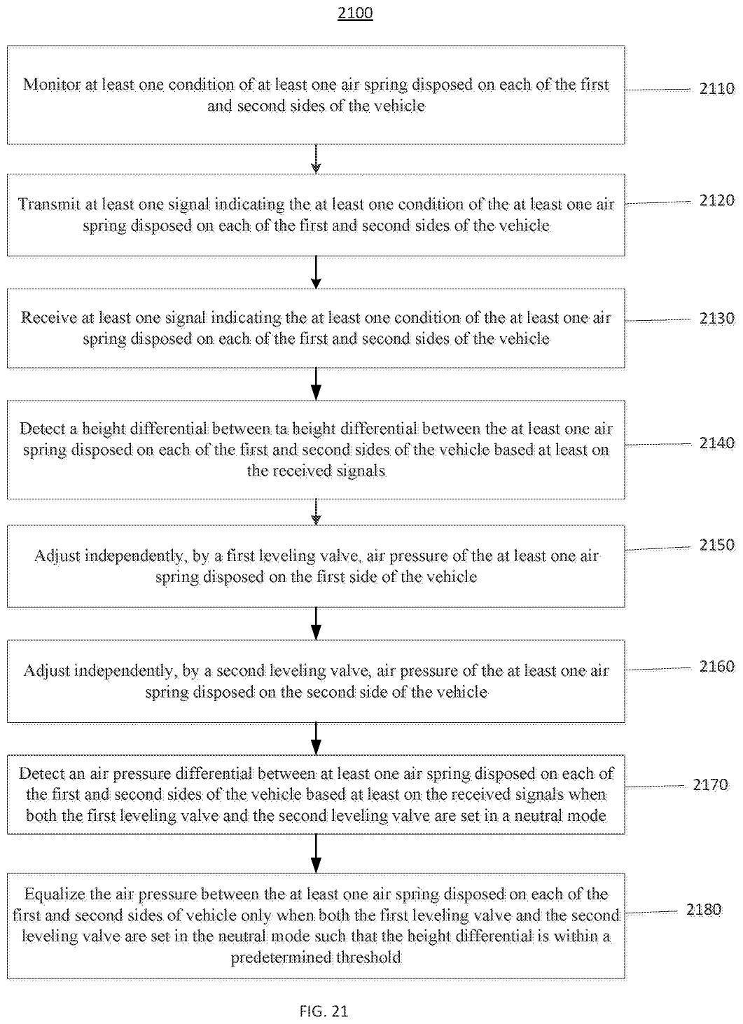

According to various embodiments, FIG. 21 illustrates a method 2100 for controlling the stability of a vehicle comprising an air management system, wherein the air management system comprising a supply tank, one or more air springs disposed on a first side of the vehicle in pneumatic communication with the supply tank and one or more air springs disposed on a second side of the vehicle in pneumatic communication with the supply tank.

In various examples, the method 2100 comprises a step 2110 of monitoring, by one or more sensors, at least one condition of at least one air spring disposed on each of the first and second sides of the vehicle.

In various examples, the method 2100 comprises a step 2120 of transmitting, by the one or more sensors, at least one signal indicating the at least one condition of the at least one air spring disposed on each of the first and second sides of the vehicle.

In various examples, the method 2100 comprises a step 2130 of receiving, by a processing module, at least one signal indicating the at least one condition of the at least one air spring disposed on each of the first and second sides of the vehicle.

In various examples, the method 2100 comprises a step 2140 of detecting, by the processing module, a height differential between the at least one air spring disposed on each of the first and second sides of the vehicle based at least on the received signals.

In various examples, the method 2100 comprises a step 2150 of independently adjusting, by a first leveling valve, air pressure of the at least one air spring disposed on the first side of the vehicle such that the first leveling valve is either supplying air from the air supply tank to the at least one air spring disposed on the first side of the vehicle or removing air from the at least one air spring disposed on the first side of the vehicle to the atmosphere.

In various examples, the method 2100 comprises a step 2160 of independently adjusting, by a second leveling valve, air pressure of the at least one air spring disposed on the second side of the vehicle such that the second leveling valve is either supplying air from the air supply tank to the at least one air spring disposed on the second side of the vehicle or removing air from the at least one air spring disposed on the second side of the vehicle to the atmosphere.

In various examples, the method 2100 comprises a step 2170 of detecting, by the processing module, an air pressure differential between at least one air spring disposed on each of the first and second sides of the vehicle based at least on the received signals when both the first leveling valve and the second leveling valve are set in a neutral mode such that the height differential is within a predetermined threshold such that first and second leveling valves are neither supplying air from the air supply tank nor removing air into the atmosphere.

In various examples, the method 2100 comprises a step 2180 of equalizing, by the first and second leveling valves, the air pressure between the at least one air spring disposed on each of the first and second sides of vehicle only when both the first leveling valve and the second leveling valve are set in the neutral mode such that the height differential is within a predetermined threshold.

All the configurations of the air management systems described herein may be incorporated with any type of vehicle, trailer, or towable, including but not limited to, sport-utility vehicles, passenger vehicles, racing vehicles, pick-up trucks, dump trucks, freight carriers, trailers of any type including trailers for boats, cattle, horses, heavy equipment, tractors, agriculture implements (e.g., granular spreaders, fertilizer sprayers and other types of sprayers, feeders and spreaders), liquid hauling vehicles, baffled and unbaffled liquid tankers, machinery, towing equipment, rail vehicles, road-rail vehicles, street cars, and any other type of chassis having air bags, etc.

The air management systems described herein may significantly increase tire life both in terms of reducing wear and resulting in even wear, even when the tires are not rotated. In one exemplary aspect, truck tires having an average life of 100,000 km when mounted on trucks that are not equipped with the air management systems described herein, experience significantly reduced wear when mounted on identical trucks that are equipped with the air management systems described herein. In certain aspects, average truck tire life is extended by at least 20%, and in some instances by up to 30%, 40%, 50%, or more. As such, an unexpected and significant financial, time (reduced time waste in rotating, changing, retreading, and replacing tires), and environmental savings is realized as additional surprising advantages of the inventions of this disclosure.

The air management systems described herein may significantly reduce the unsafe effects of wind shears on vehicles traveling at speed, particularly on truck trailers. Wind shears destabilize trucks hauling trailers at highway speeds and have caused such trailers to overturn leading to devastating injuries and losses of life, cargos, and multi-vehicle wrecks. In one exemplary aspect, trailers and recreational vehicles that are equipped with the air management systems described herein may be significantly more stable and resistant to wind shear forces at highway speeds. As such, an unexpected and significant safety and comfort advantage is realized as additional surprising advantages of the inventions of this disclosure.

The air management systems described herein may significantly reduce road noise, vibrations, and discomfort for drivers, passengers as well as live cargo including livestock, horses and the like. In one exemplary aspect, road noise, vibrations, and discomfort are significantly reduced such that drivers that could previously drive large vehicles only a few hundred miles per day due to discomfort are able to drive significantly longer distances due to the reduction in aches, pains, discomfort and fatigue, which is achieved from very noticeably improved ride quality and stability. As such, an unexpected and significant comfort advantage is realized as additional surprising advantages of the inventions of this disclosure.

The air management systems described herein may significantly reduce or even eliminate vehicle nose-diving when braking. Such nose-diving can create unsafe conditions, is highly uncomfortable for drivers and passengers, and puts increased stress on numerous vehicle components. By reducing and in many cases eliminating such nose-diving, an unexpected and significant safety and comfort advantage is realized as additional surprising advantages of the inventions of this disclosure.

The air management systems described herein may significantly increase traction resulting in improved handling, even in slippery conditions. In one exemplary aspect, trucks requiring use of four-wheel drive mode (when not equipped with the air management systems described herein) to drive through uneven and/or slippery terrain are able to be drive through the same terrain in two-wheel drive mode without losing traction and becoming immobilized. As such, an unexpected and significant safety and utility advantage is realized as additional surprising advantages of the inventions of this disclosure.

The air management systems described herein may enhance brake performance. In vehicles equipped with electronic stability systems, e.g., any electronic stability control (ESC), including, but not limited to electronic stability program (ESP), dynamic stability control (DSC), vehicle stability control (VSC), automatic traction control (ATC), the air management systems described herein have been found to reduce the incidence rate of such electronic systems applying brakes because the vehicle is maintained in a level and stable position, and thereby avoids activation of such electronic systems, which may enhance brake performance and life. The systems described herein may be fully integrated with vehicle electronic stability systems and other electronic systems including global positioning systems, cameras installed on the vehicle, Light detection and ranging (LIDAR) sensors, proximity sensors, acoustic sensors, ultrasonic sensors, and/or sonar systems so as to continuously communicate road and vehicle conditions to detect aspects of dynamic driving conditions, ground conditions, and surrounding conditions to continuously adjust air within the air management system.

As used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as well as instances in which the event, circumstance, characteristic, or property occurs to a close approximation, such as accounting for typical tolerance levels or variability of the examples described herein.

As used herein, the term “about” when used in connection with a numerical value should be interpreted to include any values which are within 5% of the recited value. Furthermore, recitation of the term about and approximately with respect to a range of values should be interpreted to include both the upper and lower end of the recited range.

As used herein, the terms “attached,” “connected,” or “fastened,” may be interpreted to include two elements that are secured together with or without contacting each other.

In the appended claims, the term “including” is used as the plain-English equivalent of the respective term “comprising.” The terms “comprising” and “including” are intended herein to be open-ended, including not only the recited elements, but further encompassing any additional elements. Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

Various embodiments of the invention comprise one or more of the following items:

1. An air management system for leveling a vehicle operated under dynamic driving conditions comprising: an air supply tank; a compressor operatively connected to the supply air tank; a system controller integrated with the supply tank; one or more air springs disposed on a first side of the vehicle and one or more air lines pneumatically connecting the one or more air springs disposed on the first side of the vehicle with the system controller; one or more air springs disposed on a second side of the vehicle and one or more air lines pneumatically connecting the one or more air springs disposed on the second side of the vehicle with the system controller; the one or more air springs disposed on a first side of the vehicle have a first leveling valve configured to adjust independently the height of at least one air spring on a first side of the vehicle; the one or more air springs disposed on a second side of the vehicle have a second leveling valve configured to adjust independently the height of at least one air spring on a second side of the vehicle; and wherein at least one air spring disposed on the first side of the vehicle and at least one air spring disposed on the second side of the vehicle comprise one or more sensors configured to monitor at least two conditions of its associated air spring and transmit a measurement signal indicating the at least two conditions of its associated air spring, wherein the at least two conditions comprise a height of its associated air spring and a pressure of its associated air spring, wherein, the system controller is configured to (i) receive the signals transmitted from the one or more sensors of each air spring, (ii) detect a height differential between at least one air spring disposed on the first side of the vehicle and at least one air spring disposed on the second side of the vehicle based at least on the received signals from the one or more sensors of each air spring, (iii) independently adjust air pressure of the at least one air spring disposed on the first side of the vehicle such that the first leveling valve is either supplying air from the air supply tank to the at least one air spring disposed on the first side of vehicle or removing air from the at least one air spring disposed on the first side of vehicle to the atmosphere, (iv) independently adjust air pressure of the at least one air spring disposed on the second side of the vehicle by a second leveling valve such that the second leveling valve is either supplying air from the air supply tank to the at least one air spring disposed on the second side of the vehicle or removing air from the at least one air spring disposed on the second side of the vehicle to the atmosphere, (v) detect a pressure differential between the at least one air springs disposed on the first side of the vehicle and the at least one air spring disposed on the second side of the vehicle based at least on the received signals from the one or more sensors of each air spring when both the first leveling valve and the second leveling valve are set in a neutral mode such that the height differential is within a predetermined threshold such that each leveling valve is neither supplying air from the air supply tank or removing air into the atmosphere, and (vi) equalize the air pressure between the at least one air spring disposed on the first side of vehicle and the at least one air spring disposed on the second side of vehicle only when both the first leveling valve and the second leveling valve are set in a neutral mode such that the height differential is within a predetermined threshold.

2. The air management system of item 1, wherein the one or more sensors comprises a height sensor configured to monitor the height of the air spring and transmit a signal indicating the height of the air spring.

3. The control unit of item 2, wherein the height sensor is an ultrasonic sensor, a laser sensor, an infrared sensor, an electromagnetic wave sensor, or a potentiometer.

4. The control unit of any one of items 1-3, wherein the one or more sensors comprise a pressure sensor configured to monitor the internal air pressure of the air spring and transmit a signal indicating the internal air pressure of the air spring.

5. The air management system of any one of items 1-4, wherein the system controller comprises a housing disposed on an exterior surface of the supply tank.

6. The air management system of any one of items 1-5, wherein the system controller comprises a housing disposed within the supply tank.

7. The air management system of any one of items 1-6, wherein the system controller comprises a first port connected to one of the air lines connected to the one or more air springs disposed on the first side of the vehicle, a second port connected to one of the air lines connected to the one or more air springs disposed on the second side of the vehicle, an exhaust port configured to exhaust air into the atmosphere, and one or more tank ports coupled to the supply tank.

8. The air management system of any one of items 1-7, wherein at least one air spring disposed on the first side of the vehicle and at least one air spring disposed on the second side of the vehicle comprise a proportional control sensor configured to monitor the air pressure of or flow rate to its associated air spring and transmit a signal indicating the air pressure of its associated air spring.

9. The air management system of item 8, wherein the system controller is configured to receive the signal transmitted from each proportional control sensor and determine a lag time for air to travel from the system controller to one of the air springs based at least on the received signals from the proportional control sensor.

10. The air management system of any one of items 1-9, wherein the air lines have equal lengths and diameters.

11. The air management system of claim of any one of items 1-10 comprising a compressor disposed within the supply tank.

12. The air management system of any one of items 1-11, wherein the one or more sensors comprises an inertial sensor unit comprising an accelerometer, a gyroscope, and a magnetometer.

13. The air management system of item 12, wherein the accelerometer is configured to measure an acceleration with respect to three axes of the vehicle; wherein the gyroscope is configured to measure an angular velocity with respect to three axes of the vehicle; and wherein the magnetometer is configured to measure the magnetic force with respect to three axes of the vehicle.

14. The air management system of item 12, wherein the one or more sensors are configured to transmit a signal indicating the measured acceleration, the angular velocity, and the magnetic force with respect to the three axes of the vehicle; wherein the system controller is configured to receive the signal transmitted from the inertial sensor unit and calculate at least one of the vehicle yaw, vehicle pitch, and vehicle roll, and the system controller is configured to determine the desired air pressure of each air spring based on at least on one of the calculated vehicle yaw, vehicle pitch, and vehicle roll.

15. A method for controlling the stability of a vehicle operated under dynamic driving conditions comprising an air management system, wherein the air management system comprises a supply tank, one or more air springs disposed on a first side of the vehicle in pneumatic communication with the supply tank and one or more air springs disposed on a second side of the vehicle in pneumatic communication with the supply tank, the method comprising: (i) monitoring, by one or more sensors, at least one condition of at least one air spring disposed on each of the first and second sides of the vehicle; (ii) transmitting, by the one or more sensors, at least one signal indicating the at least one condition of the at least one air spring disposed on each of the first and second sides of the vehicle; (iii) receiving, by a processing module, at least one signal indicating the at least one condition of the at least one air spring disposed on each of the first and second sides of the vehicle; (iv) detect, by the processing module, a height differential between the at least one air spring disposed on each of the first and second sides of the vehicle based at least on the received signals; (v) independently adjusting, by a first leveling valve, air pressure of the at least one air spring disposed on the first side of the vehicle such that the first leveling valve is either supplying air from the air supply tank to the at least one air spring disposed on the first side of the vehicle or removing air from the at least one air spring disposed on the first side of the vehicle to the atmosphere; (vi) independently adjusting, by a second leveling valve, air pressure of the at least one air spring disposed on the second side of the vehicle such that the second leveling valve is either supplying air from the air supply tank to the at least one air spring disposed on the second side of the vehicle or removing air from the at least one air spring disposed on the second side of the vehicle to the atmosphere; (vii) detect, by the processing module, an air pressure differential between at least one air spring disposed on each of the first and second sides of the vehicle based at least on the received signals when both the first leveling valve and the second leveling valve are set in a neutral mode such that the height differential is within a predetermined threshold such that first and second leveling valves are neither supplying air from the air supply tank nor removing air into the atmosphere; and (viii) equalize, by the first and second leveling valves, the air pressure between the at least one air spring disposed on each of the first and second sides of vehicle only when both the first leveling valve and the second leveling valve are set in the neutral mode such that the height differential is within the predetermined threshold.

16. The method of item 15, wherein the one or more sensors comprises a height sensor configured to monitor the height of the air spring and transmit a signal indicating the height of the air spring.

17. The method of item 16, wherein the height sensor is an ultrasonic sensor, a laser sensor, an infrared sensor, an electromagnetic wave sensor, or a potentiometer.

18. The method of any one of items 15-17, wherein the one or more sensors comprise a pressure sensor configured to monitor the internal air pressure of the air spring and transmit a signal indicating the internal air pressure of the air spring.

19. The method of any one of items 15-18, wherein the system controller comprises a housing disposed on an exterior surface of the supply tank.

20. The method of any one of items 15-19, wherein the system controller comprises a housing disposed within the supply tank.

21. The method of any one of items 15-20 comprising a compressor disposed within the supply tank.

22. An air management system for a vehicle for leveling a vehicle operated under dynamic driving conditions, the air management system comprising: a supply tank; a system controller integrated with the supply tank; one or more air springs disposed on a first side of the vehicle and one or more air lines pneumatically connecting the one or more air springs disposed on the first side of the vehicle with the system controller; one or more air springs disposed on a second side of the vehicle and one or more air lines pneumatically connecting the one or more air springs disposed on the second side of the vehicle with the system controller; and wherein at least one air spring disposed on the first side of the vehicle and at least one air spring disposed on the second side of the vehicle comprise one or more sensors configured to monitor at least one condition of its associated air spring and transmit a measurement signal indicating the at least one condition of its associated air spring; wherein the system controller is configured to: (i) receive the signals transmitted from the one or more sensors of each air spring, (ii) calculate a height or pressure differential between the air springs disposed on the first and second sides of the vehicle based at least on the received signals from the one or more sensors of each air spring, and (iii) equalize the air pressure between the at least one air spring disposed on the first side of vehicle and the at least one air spring disposed on the second side of vehicle when the calculated height or pressure differential is within a predetermined threshold by supplying air to the one or more air springs disposed on the first side of the vehicle through one or more air lines pneumatically connecting the one or more air springs disposed on the first side of the vehicle, purging air from the one or more air springs disposed on the first side of the vehicle, supplying air to the one or more air springs disposed on the second side of the vehicle through one or more air lines pneumatically connecting the one or more air springs disposed on the second side of the vehicle, and/or purging air from the one or more air springs disposed on the second side of the vehicle.

23. The air management system of item 22, wherein the system controller is configured to independently adjust the air pressure of the least one air spring disposed on the first side of vehicle to a first air pressure and independently adjust the air pressure of the at least one air spring disposed on the second side of vehicle to a second air pressure when the calculated height differential is greater than a predetermined threshold; wherein the first air pressure is not equal to the second air pressure.

24. The air management system of any one of items 22 or 23, wherein the one or more sensors comprises a height sensor configured to monitor the height of the air spring and transmit a signal indicating the height of the air spring.

25. The control unit of item 24, wherein the height sensor is an ultrasonic sensor, a laser sensor, an infrared sensor, an electromagnetic wave sensor, or a potentiometer.

26. The control unit of any one of items 22-25, wherein the one or more sensors comprise a pressure sensor configured to monitor the internal air pressure of the air spring and transmit a signal indicating the internal air pressure of the air spring.

27. The air management system of any one of items 22-26, wherein the system controller comprises a housing disposed on an exterior surface of the supply tank.

28. The air management system of any one of items 22-27, wherein the system controller comprises a housing disposed within the supply tank.

29. The air management system of any one of items 22-28, wherein the system controller comprises a first port connected to one of the air lines connected to the one or more air springs disposed on the first side of the vehicle, a second port connected to one of the air lines connected to the one or more air springs disposed on the second side of the vehicle, an exhaust port configured to exhaust air into the atmosphere, and one or more tank ports coupled to the supply tank.

30. The air management system of any one of items 22-29, wherein the system controller comprises a valve unit comprising a plurality of flow valves configured to selectively supply air from the air tank to the one or more air springs disposed on the first and second sides of the vehicle and remove air from the one or more air springs disposed on the first and second sides of the vehicle.

31. The air management system of any one of items 22-30, wherein the system controller comprises two leveling valves, each leveling valve is operatively associated with the one or more air springs disposed on a respective side of the vehicle.

32. The air management system of any one of items 22-31, wherein at least one air spring disposed on the first side of the vehicle and at least one air spring disposed on the second side of the vehicle comprise a proportional control sensor configured to monitor the air pressure of or flow rate to its associated air spring and transmit a signal indicating the air pressure of its associated air spring.

33. The air management system of item 32, wherein the system controller is configured to receive the signal transmitted from each proportional control sensor and determine a lag time for air to travel from the system controller to one of the air springs based at least on the received signals from the proportional control sensor.

34. The air management system of any one of items 22-33, wherein the air lines have equal lengths and diameters.

35. The air management system of any one of items 22-34 comprising a compressor disposed within the supply tank.

36. The air management system of any one of items 22-35, wherein the one or more sensors comprises an inertial sensor unit comprising an accelerometer, a gyroscope, and a magnetometer.

37. The air management system of item 36, wherein the accelerometer is configured to measure an acceleration with respect to three axes of the vehicle; wherein the gyroscope is configured to measure an angular velocity with respect to three axes of the vehicle; and wherein the magnetometer is configured to measure the magnetic force with respect to three axes of the vehicle.

38. The air management system of item 36, wherein the one or more sensors are configured to transmit a signal indicating the measured acceleration, the angular velocity, and the magnetic force with respect to the three axes of the vehicle; wherein the system controller is configured to receive the signal transmitted from the inertial sensor unit and calculate at least one of the vehicle yaw, vehicle pitch, and vehicle roll, and the system controller is configured to determine the desired air pressure of each air spring based on at least on one of the calculated vehicle yaw, vehicle pitch, and vehicle roll.

39. A control unit associated with an air spring of air management system for a vehicle, the control unit comprising: a housing configured to be mounted to a top plate of the air spring, wherein the housing comprises a valve chamber; a valve disposed in the valve chamber, wherein the valve is configured to selectively remove air from or supply air to a chamber of the air spring at a plurality of volumetric flow rates; one or more sensors configured to monitor at least one condition of the air spring and generate a measurement signal indicating the at least one condition of the air spring; a communication interface configured to transmit and receive data signals to and from a second control unit associated with a second air spring of the air management system; and a processing module operatively linked to the valve, the one or more sensors, and the communication interface; wherein the processing module is configured to: (i) receive one or more measurement signals from the one or more sensors of its associated air spring and one or more data signals from the second air spring, (ii) calculate a height or pressure differential between the first and second air springs based at least on the received one or more measurement signals and the one or more data signals, and (iii) actuate the valve to set an air pressure of its associated air spring to an air pressure of the second air spring when the calculated height or pressure differential is within a predetermined threshold.

40. The control unit of item 39, wherein the housing comprises: an inlet port configured to receive air flow from an air source, an outlet port configured to release air to the atmosphere, and a delivery port configured to supply or release air to and from the chamber of the air spring, wherein the valve chamber is connected to the inlet port, the outlet port, and the delivery port by a plurality of passages.

41. The control unit of any one of items 39 or 40, wherein the one or more sensors comprises a height sensor configured to monitor the height of the air spring and generate a signal indicating the height of the air spring.

42. The control unit of item 41, wherein the height sensor is an ultrasonic sensor, a laser sensor, an infrared sensor, an electromagnetic wave sensor, or a potentiometer.

43. The control unit of any one of items 39-42, wherein the one or more sensors comprise a pressure sensor configured to monitor the internal air pressure of the air spring and generate a signal indicating the internal air pressure of the air spring.

44. The control unit of any one of items 39-43, wherein the valve chamber, the valve, and the processing module are mounted below the top plate and disposed in the chamber of the air spring.

45. The control unit of any one of items 39-45, wherein the valve chamber, the valve, and the processing module are mounted above the top plate and disposed outside the chamber of the air spring.

46. The control unit of any one of items 39-45, wherein the valve comprises a cylindrical-shaped manifold, a valve member disposed in the manifold and in sliding engagement with an interior surface of the manifold, and an electronic actuator operatively linked to the valve member and the processing module; wherein the manifold comprises a plurality of openings disposed along a side surface of the manifold, and the electronic actuator is configured to actuate the valve member to slide along the longitudinal axis of the manifold to control the exposure of the plurality of openings such that air is supplied to or removed from the air spring at the desired volumetric flow rate.

47. A method for controlling the stability of a vehicle operated under dynamic driving conditions comprising an air management system, wherein the air management system comprising a supply tank, one or more air springs disposed on a first side of the vehicle in pneumatic communication with the supply tank and one or more air springs disposed on a second side of the vehicle in pneumatic communication with the supply tank, the method comprising: (i) monitoring, by one or more sensors, at least one condition of the one or more air springs disposed on the first side of a vehicle and the one or more air springs disposed on the second side of a vehicle; (ii) transmitting, by the one or more sensors, at least one signal indicating the at least one condition of the one or more air springs disposed on the first and second sides of the vehicle; (iii) receiving, by a processing module, at least one signal indicating the at least one condition of the one or more air springs disposed on the first and second sides of the vehicle; (iv) calculating, by the processing module, a height or pressure differential between the one or more air springs disposed on the first side of the vehicle and the one or more air springs disposed on the second side of the vehicle based on at least the received signals; and (v) actuating, by the processing module, one or more valves to equalize the air pressure between the one or more air springs disposed on the first side of the vehicle and the one or more air springs disposed on the second side of the vehicle when the calculated differential is within a predetermined threshold.

48. The method of item 47, wherein the one or more sensors comprises a height sensor configured to monitor the height of the air spring and transmit a signal indicating the height of the air spring.

49. The method of item 48, wherein the height sensor is an ultrasonic sensor, a laser sensor, an infrared sensor, an electromagnetic wave sensor, or a potentiometer.

50. The method of item of any one of claims 47-49, wherein the one or more sensors comprise a pressure sensor configured to monitor the internal air pressure of the air spring and transmit a signal indicating the internal air pressure of the air spring.

51. The method of any one of items 47-50, wherein the system controller comprises a housing disposed on an exterior surface of the supply tank.

52. The method of any one of items 47-51, wherein the system controller comprises a housing disposed within the supply tank.

53. The method of any one of items 47-52 comprising a compressor disposed within the supply tank.

54. The method, system, and/or control unit of any one of items 1-53, wherein one or more steps of the method for controlling the stability of a vehicle operated under dynamic driving conditions of this disclosure are continuously implemented while the vehicle is operated under dynamic driving conditions such that any step is repeated one or more times in response to changing driving conditions.

55. The method, system, and/or control unit of any one of items 1-54, wherein the air management system dynamically receives and processes sensor data, and transmits commands to supply and purge air continuously while the vehicle is operated under dynamic driving conditions.

While the subject matter of this disclosure has been described and shown in considerable detail with reference to certain illustrative examples, including various combinations and sub-combinations of features, those skilled in the art will readily appreciate other aspects and variations and modifications thereof as encompassed within the scope of the present disclosure. Moreover, the descriptions of such aspects, examples, combinations, and sub-combinations are not intended to convey that the claimed subject matter requires features or combinations of features other than those expressly recited in the claims. Accordingly, the scope of this disclosure is intended to include all modifications and variations encompassed within the spirit and scope of the following appended claims.

1. An air management system for leveling a vehicle operated under dynamic driving conditions comprising:
an air supply tank;
a compressor operatively connected to the supply air tank;
a system controller integrated with the supply tank;
one or more air springs disposed on a first side of the vehicle and one or more air lines pneumatically connecting the one or more air springs disposed on the first side of the vehicle with the system controller;
one or more air springs disposed on a second side of the vehicle and one or more air lines pneumatically connecting the one or more air springs disposed on the second side of the vehicle with the system controller;
the one or more air springs disposed on a first side of the vehicle have a first leveling valve configured to adjust independently the height of at least one air spring on a first side of the vehicle;
the one or more air springs disposed on a second side of the vehicle have a second leveling valve configured to adjust independently the height of at least one air spring on a second side of the vehicle; and
wherein at least one air spring disposed on the first side of the vehicle and at least one air spring disposed on the second side of the vehicle comprise one or more sensors configured to monitor at least two conditions of its associated air spring and transmit a measurement signal indicating the at least two conditions of its associated air spring,
wherein the at least two conditions comprise a height of its associated air spring and a pressure of its associated air spring,
wherein, the system controller is configured to (i) receive the signals transmitted from the one or more sensors of each air spring, (ii) detect a height differential between at least one air spring disposed on the first side of the vehicle and at least one air spring disposed on the second side of the vehicle based at least on the received signals from the one or more sensors of each air spring, (iii) independently adjust air pressure of the at least one air spring disposed on the first side of the vehicle such that the first leveling valve is either supplying air from the air supply tank to the at least one air spring disposed on the first side of vehicle or removing air from the at least one air spring disposed on the first side of vehicle to the atmosphere, (iv) independently adjust air pressure of the at least one air spring disposed on the second side of the vehicle by a second leveling valve such that the second leveling valve is either supplying air from the air supply tank to the at least one air spring disposed on the second side of the vehicle or removing air from the at least one air spring disposed on the second side of the vehicle to the atmosphere, (v) detect a pressure differential between the at least one air springs disposed on the first side of the vehicle and the at least one air spring disposed on the second side of the vehicle based at least on the received signals from the one or more sensors of each air spring when both the first leveling valve and the second leveling valve are set in a neutral mode such that the height differential is within a predetermined threshold such that each leveling valve is neither supplying air from the air supply tank or removing air into the atmosphere, and (vi) equalize the air pressure between the at least one air spring disposed on the first side of vehicle and the at least one air spring disposed on the second side of vehicle only when both the first leveling valve and the second leveling valve are set in a neutral mode such that the height differential is within a predetermined threshold.

2. The air management system of claim 1, wherein the one or more sensors comprises a height sensor configured to monitor the height of the air spring and transmit a signal indicating the height of the air spring.

3. The control unit of claim 2, wherein the height sensor is an ultrasonic sensor, a laser sensor, an infrared sensor, an electromagnetic wave sensor, or a potentiometer.

4. The control unit of claim 1, wherein the one or more sensors comprise a pressure sensor configured to monitor the internal air pressure of the air spring and transmit a signal indicating the internal air pressure of the air spring.

5. The air management system of claim 1, wherein the system controller comprises a housing disposed on an exterior surface of the supply tank.

6. The air management system of claim 1, wherein the system controller comprises a housing disposed within the supply tank.

7. The air management system of claim 1, wherein the system controller comprises a first port connected to one of the air lines connected to the one or more air springs disposed on the first side of the vehicle, a second port connected to one of the air lines connected to the one or more air springs disposed on the second side of the vehicle, an exhaust port configured to exhaust air into the atmosphere, and one or more tank ports coupled to the supply tank.

8. The air management system of claim 1, wherein at least one air spring disposed on the first side of the vehicle and at least one air spring disposed on the second side of the vehicle comprise a proportional control sensor configured to monitor the air pressure of or flow rate to its associated air spring and transmit a signal indicating the air pressure of its associated air spring.

9. The air management system of claim 8, wherein the system controller is configured to receive the signal transmitted from each proportional control sensor and determine a lag time for air to travel from the system controller to one of the air springs based at least on the received signals from the proportional control sensor.

10. The air management system of claim 1, wherein the air lines have equal lengths and diameters.

11. The air management system of claim 1 comprising a compressor disposed within the supply tank.

12. The air management system of claim 1, wherein the one or more sensors comprises an inertial sensor unit comprising an accelerometer, a gyroscope, and a magnetometer.

13. The air management system of claim 12, wherein the accelerometer is configured to measure an acceleration with respect to three axes of the vehicle;
wherein the gyroscope is configured to measure an angular velocity with respect to three axes of the vehicle; and
wherein the magnetometer is configured to measure the magnetic force with respect to three axes of the vehicle.

14. The air management system of claim 12, wherein the one or more sensors are configured to transmit a signal indicating the measured acceleration, the angular velocity, and the magnetic force with respect to the three axes of the vehicle;
wherein the system controller is configured to receive the signal transmitted from the inertial sensor unit and calculate at least one of the vehicle yaw, vehicle pitch, and vehicle roll, and the system controller is configured to determine the desired air pressure of each air spring based on at least on one of the calculated vehicle yaw, vehicle pitch, and vehicle roll.

15. A method for controlling the stability of a vehicle operated under dynamic driving conditions comprising an air management system, wherein the air management system comprises a supply tank, one or more air springs disposed on a first side of the vehicle in pneumatic communication with the supply tank and one or more air springs disposed on a second side of the vehicle in pneumatic communication with the supply tank, the method comprising:
(i) monitoring, by one or more sensors, at least one condition of at least one air spring disposed on each of the first and second sides of the vehicle;
(ii) transmitting, by the one or more sensors, at least one signal indicating the at least one condition of the at least one air spring disposed on each of the first and second sides of the vehicle;
(iii) receiving, by a processing module, at least one signal indicating the at least one condition of the at least one air spring disposed on each of the first and second sides of the vehicle;
(iv) detecting, by the processing module, a height differential between the at least one air spring disposed on each of the first and second sides of the vehicle based at least on the received signals;
(v) independently adjusting, by a first leveling valve, air pressure of the at least one air spring disposed on the first side of the vehicle such that the first leveling valve is either supplying air from the air supply tank to the at least one air spring disposed on the first side of the vehicle or removing air from the at least one air spring disposed on the first side of the vehicle to the atmosphere;
(vi) independently adjusting, by a second leveling valve, air pressure of the at least one air spring disposed on the second side of the vehicle such that the second leveling valve is either supplying air from the air supply tank to the at least one air spring disposed on the second side of the vehicle or removing air from the at least one air spring disposed on the second side of the vehicle to the atmosphere;
(vii) detecting, by the processing module, an air pressure differential between at least one air spring disposed on each of the first and second sides of the vehicle based at least on the received signals when both the first leveling valve and the second leveling valve are set in a neutral mode such that the height differential is within a predetermined threshold such that first and second leveling valves are neither supplying air from the air supply tank nor removing air into the atmosphere; and
(viii) equalizing, by the first and second leveling valves, the air pressure between the at least one air spring disposed on each of the first and second sides of vehicle only when both the first leveling valve and the second leveling valve are set in the neutral mode such that the height differential is within the predetermined threshold.

16. The method of claim 15, wherein the one or more sensors comprises a height sensor configured to monitor the height of the air spring and transmit a signal indicating the height of the air spring.

17. The method of claim 16, wherein the height sensor is an ultrasonic sensor, a laser sensor, an infrared sensor, an electromagnetic wave sensor, or a potentiometer.

18. The method of claim 15, wherein the one or more sensors comprise a pressure sensor configured to monitor the internal air pressure of the air spring and transmit a signal indicating the internal air pressure of the air spring.

19. The method of claim 15, wherein the system controller comprises a housing disposed on an exterior surface of the supply tank.

20. The method of claim 15, wherein the system controller comprises a housing disposed within the supply tank.

21. The method of claim 15 comprising a compressor disposed within the supply tank.

22. An air management system for a vehicle for leveling a vehicle operated under dynamic driving conditions, the air management system comprising:
a supply tank;
a system controller integrated with the supply tank;
one or more air springs disposed on a first side of the vehicle and one or more air lines pneumatically connecting the one or more air springs disposed on the first side of the vehicle with the system controller;
one or more air springs disposed on a second side of the vehicle and one or more air lines pneumatically connecting the one or more air springs disposed on the second side of the vehicle with the system controller; and
wherein at least one air spring disposed on the first side of the vehicle and at least one air spring disposed on the second side of the vehicle comprise one or more sensors configured to monitor at least one condition of its associated air spring and transmit a measurement signal indicating the at least one condition of its associated air spring;
wherein the system controller is configured to: (i) receive the signals transmitted from the one or more sensors of each air spring, (ii) calculate a height or pressure differential between the air springs disposed on the first and second sides of the vehicle based at least on the received signals from the one or more sensors of each air spring, and (iii) equalize the air pressure between the at least one air spring disposed on the first side of vehicle and the at least one air spring disposed on the second side of vehicle when the calculated height or pressure differential is within a predetermined threshold by supplying air to the one or more air springs disposed on the first side of the vehicle through one or more air lines pneumatically connecting the one or more air springs disposed on the first side of the vehicle, purging air from the one or more air springs disposed on the first side of the vehicle, supplying air to the one or more air springs disposed on the second side of the vehicle through one or more air lines pneumatically connecting the one or more air springs disposed on the second side of the vehicle, and/or purging air from the one or more air springs disposed on the second side of the vehicle.

23. The air management system of claim 22, wherein the system controller is configured to independently adjust the air pressure of the least one air spring disposed on the first side of vehicle to a first air pressure and independently adjust the air pressure of the at least one air spring disposed on the second side of vehicle to a second air pressure when the calculated height differential is greater than a predetermined threshold;
wherein the first air pressure is not equal to the second air pressure.

24. The air management system of claim 22, wherein the one or more sensors comprises a height sensor configured to monitor the height of the air spring and transmit a signal indicating the height of the air spring.

25. The control unit of claim 24, wherein the height sensor is an ultrasonic sensor, a laser sensor, an infrared sensor, an electromagnetic wave sensor, or a potentiometer.

26. The control unit of claim 22, wherein the one or more sensors comprise a pressure sensor configured to monitor the internal air pressure of the air spring and transmit a signal indicating the internal air pressure of the air spring.

27. The air management system of claim 22, wherein the system controller comprises a housing disposed on an exterior surface of the supply tank.

28. The air management system of claim 22, wherein the system controller comprises a housing disposed within the supply tank.

29. The air management system of claim 22, wherein the system controller comprises a first port connected to one of the air lines connected to the one or more air springs disposed on the first side of the vehicle, a second port connected to one of the air lines connected to the one or more air springs disposed on the second side of the vehicle, an exhaust port configured to exhaust air into the atmosphere, and one or more tank ports coupled to the supply tank.

30. The air management system of claim 22, wherein the system controller comprises a valve unit comprising a plurality of flow valves configured to selectively supply air from the air tank to the one or more air springs disposed on the first and second sides of the vehicle and remove air from the one or more air springs disposed on the first and second sides of the vehicle.

31. The air management system of claim 22, wherein the system controller comprises two leveling valves, each leveling valve is operatively associated with the one or more air springs disposed on a respective side of the vehicle.

32. The air management system of claim 22, wherein at least one air spring disposed on the first side of the vehicle and at least one air spring disposed on the second side of the vehicle comprise a proportional control sensor configured to monitor the air pressure of or flow rate to its associated air spring and transmit a signal indicating the air pressure of its associated air spring.

33. The air management system of claim 32, wherein the system controller is configured to receive the signal transmitted from each proportional control sensor and determine a lag time for air to travel from the system controller to one of the air springs based at least on the received signals from the proportional control sensor.

34. The air management system of claim 22, wherein the air lines have equal lengths and diameters.

35. The air management system of claim 22 comprising a compressor disposed within the supply tank.

36. The air management system of claim 22, wherein the one or more sensors comprises an inertial sensor unit comprising an accelerometer, a gyroscope, and a magnetometer.

37. The air management system of claim 36, wherein the accelerometer is configured to measure an acceleration with respect to three axes of the vehicle;
wherein the gyroscope is configured to measure an angular velocity with respect to three axes of the vehicle; and
wherein the magnetometer is configured to measure the magnetic force with respect to three axes of the vehicle.

38. The air management system of claim 36, wherein the one or more sensors are configured to transmit a signal indicating the measured acceleration, the angular velocity, and the magnetic force with respect to the three axes of the vehicle;
wherein the system controller is configured to receive the signal transmitted from the inertial sensor unit and calculate at least one of the vehicle yaw, vehicle pitch, and vehicle roll, and the system controller is configured to determine the desired air pressure of each air spring based on at least on one of the calculated vehicle yaw, vehicle pitch, and vehicle roll.

39. A control unit associated with an air spring of air management system for a vehicle, the control unit comprising:
a housing configured to be mounted to a top plate of the air spring, wherein the housing comprises a valve chamber;
a valve disposed in the valve chamber, wherein the valve is configured to selectively remove air from or supply air to a chamber of the air spring at a plurality of volumetric flow rates;
one or more sensors configured to monitor at least one condition of the air spring and generate a measurement signal indicating the at least one condition of the air spring;
a communication interface configured to transmit and receive data signals to and from a second control unit associated with a second air spring of the air management system; and
a processing module operatively linked to the valve, the one or more sensors, and the communication interface;
wherein the processing module is configured to: (i) receive one or more measurement signals from the one or more sensors of its associated air spring and one or more data signals from the second air spring, (ii) calculate a height or pressure differential between the first and second air springs based at least on the received one or more measurement signals and the one or more data signals, and (iii) actuate the valve to set an air pressure of its associated air spring to an air pressure of the second air spring when the calculated height or pressure differential is within a predetermined threshold.

40. The control unit of claim 39, wherein the housing comprises:
an inlet port configured to receive air flow from an air source,
an outlet port configured to release air to the atmosphere, and
a delivery port configured to supply or release air to and from the chamber of the air spring,
wherein the valve chamber is connected to the inlet port, the outlet port, and the delivery port by a plurality of passages.

41. The control unit of claim 39, wherein the one or more sensors comprises a height sensor configured to monitor the height of the air spring and generate a signal indicating the height of the air spring.

42. The control unit of claim 41, wherein the height sensor is an ultrasonic sensor, a laser sensor, an infrared sensor, an electromagnetic wave sensor, or a potentiometer.

43. The control unit of claim 39, wherein the one or more sensors comprise a pressure sensor configured to monitor the internal air pressure of the air spring and generate a signal indicating the internal air pressure of the air spring.

44. The control unit of claim 39, wherein the valve chamber, the valve, and the processing module are mounted below the top plate and disposed in the chamber of the air spring.

45. The control unit of claim 39, wherein the valve chamber, the valve, and the processing module are mounted above the top plate and disposed outside the chamber of the air spring.

46. The control unit of claim 39, wherein the valve comprises a cylindrical-shaped manifold, a valve member disposed in the manifold and in sliding engagement with an interior surface of the manifold, and an electronic actuator operatively linked to the valve member and the processing module;
wherein the manifold comprises a plurality of openings disposed along a side surface of the manifold, and the electronic actuator is configured to actuate the valve member to slide along the longitudinal axis of the manifold to control the exposure of the plurality of openings such that air is supplied to or removed from the air spring at the desired volumetric flow rate.

47. A method for controlling the stability of a vehicle operated under dynamic driving conditions comprising an air management system, wherein the air management system comprising a supply tank, one or more air springs disposed on a first side of the vehicle in pneumatic communication with the supply tank and one or more air springs disposed on a second side of the vehicle in pneumatic communication with the supply tank, the method comprising:
(i) monitoring, by one or more sensors, at least one condition of the one or more air springs disposed on the first side of a vehicle and the one or more air springs disposed on the second side of a vehicle;
(ii) transmitting, by the one or more sensors, at least one signal indicating the at least one condition of the one or more air springs disposed on the first and second sides of the vehicle;
(iii) receiving, by a processing module, at least one signal indicating the at least one condition of the one or more air springs disposed on the first and second sides of the vehicle;
(iv) calculating, by the processing module, a height or pressure differential between the one or more air springs disposed on the first side of the vehicle and the one or more air springs disposed on the second side of the vehicle based on at least the received signals; and
(v) actuating, by the processing module, one or more valves to equalize the air pressure between the one or more air springs disposed on the first side of the vehicle and the one or more air springs disposed on the second side of the vehicle when the calculated differential is within a predetermined threshold.

48. The method of claim 47, wherein the one or more sensors comprises a height sensor configured to monitor the height of the air spring and transmit a signal indicating the height of the air spring.

49. The method of claim 48, wherein the height sensor is an ultrasonic sensor, a laser sensor, an infrared sensor, an electromagnetic wave sensor, or a potentiometer.

50. The method of claim 47, wherein the one or more sensors comprise a pressure sensor configured to monitor the internal air pressure of the air spring and transmit a signal indicating the internal air pressure of the air spring.

51. The method of claim 47, wherein the system controller comprises a housing disposed on an exterior surface of the supply tank.

52. The method of claim 47, wherein the system controller comprises a housing disposed within the supply tank.

53. The method of claim 47 comprising a compressor disposed within the supply tank.
